(19) United States
(12) Patent Application Publication
(10) Pub. No.: US 2004/0053099 A1
(43) Pub. Date: Mar. 18, 2004

(54) Integrated and modular BSP/MEA/Manifold plates and compliant contacts for fuel cells

(76) Inventors: Jerrold E. Franklin, Sacramento, CA (US); Eric S. Mettler, Cameron Park, CA (US); Muralidharan P. Arikara, Folsom, CA (US); Lawrence Bawden JR., El Dorado Hills, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/369,257

(22) Filed: Feb. 18, 2003

Related U.S. Application Data
(63) Continuation of application No. PCT/US01/24105, filed on Jul. 31, 2001.
Application No. PCT/US01/24105 is a continuation-in-part of application No. 09/834,389, filed on Apr. 13, 2001.
Application No. PCT/US01/24105 is a continuation-in-part of application No. 09/834,390, filed on Apr. 13, 2001, now abandoned.
(60) Provisional application No. 60/226,471, filed on Aug. 18, 2000.
(60) Provisional application No. 60/249,662, filed on Nov. 17, 2000.
(60) Provisional application No. 60/226,471, filed on Aug. 18, 2000.

(51) Int. Cl. H01M 8/10; H01M 2/08

(52) U.S. Cl. 429/30; 429/35; 429/127; 429/36

(57) ABSTRACT

The present invention concerns improvements in fuel cell fabrication. Arrays of independent acting compliant electrical contacts are incorporated within a fuel cell which improve fuel cell operation by creating uniform and intimate electrical contact with the adjacent membrane electrode assembly (MEA). These compliant electrical contacts provide substantial uniform internal pressure distribution and substantially uniform electrical contact. In one embodiment, the array of compliant electrical contacts are in the form of a plurality of metal springs of various configurations which are electrically and mechanical contacted to a conducting base plate. In another embodiment the array of compliant electrical contacts are in the form of a plurality of small metal pins or rods which are electrically and mechanically contacted to a conducting base plate. It concerns improved, integrated and modular BSP/MEA/Manifolds, which facilitates single cell (module) leak and performance testing prior to assembly in a fuel cell stack as well as facilitating manufacturing and cost reduction. In particular, the present invention relates to a fuel cell, which includes: a) A single flexible or ridged separator plate; b) a flexible membrane electrode assembly; c) a flexible bond interposed between said single flexible or ridged separator plate and said flexible membrane electrode assembly, wherein said flexible bond between said flexible or ridged separator plate and said flexible membrane electrode assembly comprises the fuel cell, and wherein said flexible bond is an adhesive bond which encapsulates edge-portions of said flexible or ridged separator plate and said flexible membrane electrode assembly and wherein said flexible bond seals the edge portions of said flexible membrane assembly to prevent the release of reactants from the fuel cell. In some embodiments the adhesive bond comprises a flexible gasket; d) manifold for the delivery and removal of reactants and reactant products to and from the fuel cell reactive areas where said manifolds may be either a single or multiple manifolds; and e) a bond interposed between said manifold and said single flexible or ridged separator plate, wherein said bond affixes said manifold to said flexible or ridged separator plate and wherein said bond provides a seal between said manifold and said flexible or ridged separator plate to prevent the release of reactants from the fuel cell. It also eliminates some gaskets and simplifies assembly.

### RELATED APPLICATIONS

This PCT application is a continuation-in-part of U.S. Ser. No. 09/834,389, filed Apr. 13, 2001 which is a continuation-in-part of U.S. Ser. No. 60/226,471, filed Aug. 18, 2000 and U.S. Ser. No. 60/249,662, filed Nov. 17, 2000, and U.S. Ser. No. 09/834,390, filed Apr. 13, 2001, all of which are incorporated herein by reference in their entirety.

### BACKGROUND OF THE INVENTION

1. Field of the Invention

Fuel cells are energy conversion devices that use hydrogen, the most abundant fuel on earth, and oxygen, usually from the air, to create electricity through a chemical conversion process, without combustion and without harmful emissions. The voltage and current output depends on the number of cells in the stack, total active surface area and efficiency. The basic process, for a single cell, is shown in FIG. 1.

The present invention relates to electrochemical energy converters with a polymer electrolyte membrane (PEM), such as fuel cells or electrolyzer cells or stacks of such cells, wherein the individual cells are modular units which have integrated the bipolar separator plate (BSP), the membrane electrode assembly (MEA) and the reactant and coolant manifolds. These individual components are assembled into integrated modules and these modules are tested individually for full functionality before being assembled into a complete fuel cell unit (stack) as individual components. In particular the several components of the integrated modular BSP/MEA/Manifolds (fuel cell module), i.e., the bipolar separator plate, membrane electrode assembly, separate diffusion layers (if used), gaskets (if used), manifolds, adhesives, and seals (if used) are manufactured as separate entities before being incorporated into a fuel cell module before being assembled in a complete fuel cell unit (stack). In a number of embodiments, these fuel cell components can be as large or as small as the end use requires.

This invention also concerns compliant electrical contacts for fuel cell use to create, adjust and distribute internal forces and loads to optimize contact area and contact pressure to increase fuel cell performance. In a number of embodiments, an array of metal springs of different shapes and configurations contact the adjacent electrode. In another embodiment, a series of electrical contact points similar to a “bed of nails” is used to adjust forces and pressure.

2. Description of the Related Art

Electrochemical cells comprising Polymer Electrolyte Membranes (PEM) are operated as fuel cells wherein a fuel and an oxidizer are electrochemically converted at the cell electrodes to produce electrical power, or as electrolyzers wherein an external electrical current is passed between the cell electrodes, typically through water, resulting in generation of hydrogen and oxygen at the respective electrodes of the cells.

Traditional fuel cell stacks 1, see FIG. 2, are made of many individual cells 2, see FIG. 3, which are stacked together. The ability to achieve the required gas and liquid sealing and to maintain intimate electrical contact has traditionally been accomplished with the use of relatively thick and heavy “end plates”(3, 4) with the fuel cell stack 5 held together by heavy tie-rods or bolts 6 and nuts 7 (or other fasteners) in a “filter-press” type of arrangement, see FIGS. 2 and 4. Disassembly and analysis of fuel cell stacks built by traditional and other methods reveals evidence of incomplete electrical contact between bipolar separator plates (BSPs) 8 and the membrane electrode assembly (MEAs) 9, which results in poor electrical conduction, lower cell performance, often along with evidence of gas and liquid leakage.

The traditional method of assembly of Proton Exchange Membrane (PEM) fuel cells requires several parallel and serial mechanical processes that must be accomplished simultaneously for each individual cell, see FIG. 3.

1. The Membrane Electrode Assembly (MEA) 9 must be sealed to the Bipolar Separator Plates (BSPs) 8 at each plate/MEA interface, via gaskets such as 10A and 10B.

2. The fuel, oxidizer and coolant manifolds 11A and 11B are all required to be sealed at the same time during fabrication as the MEA is sealed to the BSP.

3. The BSPs 8 must be in intimate electrical contact with the electrode assembly 9, across its entire surface area, at all times for optimum performance.

As the traditional fuel cell stack 1 is assembled, each individual cell (layer) 2 must seal, manage gasses and liquid, produce power and conduct current. Each cell relies on all the other cells for these functions. Additionally, all seals and electrical contacts must be made concurrently at the time of assembly of the stack, see FIGS. 2 and 3.

The assembly of a traditional PEM cell stack which comprises a plurality of PEM cells each having many separate gaskets which must be fitted to or formed on the various components is labor-intensive, costly and in a manner generally unsuited to high volume manufacture due to the multitude of parts and number of assembly steps required.

With the conventional PEM stack design 1, see FIG. 2, it is problematic to remove and repair an individual cell 2 (see FIG. 3) or to identify or test which cell or cells in the stack may require repair due to leakage or performance problems. If there is a leak, then in many cases, the entire stack assembly is required to be dissembled. The disassembly of a stack consisting of multiple cells, each comprising separate cell components can be very costly as in many instances, after the removal of one cell, the gaskets of the remaining cells may need to be replaced before the stack can be reassembled and operated. Additionally, the potential for damage to the MEA is very high. Upon reassembly, there is no assurance of the performance or of a leak tight condition. This is a very time consuming and therefore costly process.

Some patents of interest are listed below.

R. G. Spear, et al. in U.S. Pat. No. 5,683,828, assigned to H Power Corporation disclose metal platelet fuel cells production and operation methods.

R. G. Spear, et al. in U.S. Pat. No. 5,858,567, assigned to H Power Corporation disclose fuel cells employing integrated fluid management platelet technology.

R. G. Spear, et al. in U.S. Pat. No. 5,863,671, assigned to H Power Corporation disclose plastic platelet fuel cells employing integrated fluid management.

R. G. Spear, et al. in U.S. Pat. No. 6,051,331 assigned to H Power Corporation disclose fuel cell platelet separators having coordinate features.

These four U.S. patents to Spear et al. describe conventional fuel cell assembly.

W. A. Fuglevand, et al. in U.S. Pat. No. 6,030,718, assigned to Avista Corporation disclose a proton exchange membrane fuel cell power system.

D. G Epp, et al. in U.S. Pat. No. 5,176,966 disclose a fuel cell membrane electrode and a seal assembly.

W. J. Fletcher, et al. in U.S. Pat. No. 5,470,671 disclose an electrochemical fuel cell which employs ambient air as both oxidant and coolant.

W. D. Ernest, et al. in U.S. Pat. No. 5,945,232 disclose a PEM-type fuel cell assembly having multiple parallel fuel cell sub-stacks employing shared fluid plate assemblies and shared membrane electrode assemblies.

R. A. Mercuri, et al; in U.S. Pat. No. 5,976,727 disclose an electrically conductive seal for fuel cell components.

R. D. Breault, et al. in U.S. Pat. No. 6,020,083 disclose a membrane electrode assembly for a PEM fuel cell.

R. H. Burton, et al. in U.S. Pat. No. 6,057,054 disclose a membrane electrode assembly for an electrochemical fuel cell and a method of making an improved membrane electrode assembly.

J. A. Ronne, et al. in U.S. Pat. No. 6,066,409 disclose an electrochemical fuel cell stack with improved reactant manifolding and sealing.

O. Schmidt et al. in U.S. Pat. No. 6,080,503 disclose polymer electrolyte membrane fuel cells and stacks with adhesively bonded layers.

Other art of general interest includes, for example: U.S. Pat. No. 5,338,621; European Patent 446,680; U.S. Pat. No. 5,328,779; U.S. Pat. No. 5,084,364; U.S. Pat. No. 4,548,675 and U.S. Pat. No. 4,445,994.

All of the references, patents, patent applications, standards, etc. cited in this application are incorporated by reference in their entirety.

With reference to FIG. 3 and claims 1 and 2 of U.S. Pat. No. 6,080,503 which is incorporated herein by reference, the adhesive bonding agent used is for bonding “a first separator plate” and “a second separator plate” to a membrane electrode assembly”, in the current embodiment a single separator plate is bonded to a single MEA and to manifolds which are external to the membrane assembly with no through passages holing the membrane. This embodiment forms a fuel cell module (assembly).

It is apparent from the above discussion that existing fuel cell technology can be significantly improved using compliant contacts, modular components and in the assembly of the multiple fuel cell unit (stack). This invention concerns an improved, integrated and modular BSP/MEA/Manifold assembly, which facilitates single cell (module) leak and performance testing prior to assembly. It also eliminates the need for gaskets between adjacent BSP and simplifies assembly. The present invention of modular, integrated units provides such improvements for a fuel cell. Specifically incorporated by reference in their entirety are pending U. S. Provisional Patent Serial No. 60/226,471, filed Aug. 18, 2000 and pending U.S. Ser. No. 09/834,390, filed Apr. 13, 2000.

### SUMMARY OF THE INVENTION

This invention concerns an improved, integrated and modular BSP/MEA/Manifold, which facilitates single cell (module) assembly as well as composed leak and performance testing of the modules prior to stack assembly. It also eliminates inter BSP gaskets and seals and simplifies cell assembly as well as stack assembly.

In addition, thin, flexible or ridged BSPs are used to manage reactants and maintain separation of the fuel and oxygen (or air); provide structural support for the MEAs and provide electrical contact and conductance. They also provide for the decoupling of the electrical contacts and for the sealing from the fuel cell stack assembly, thus reducing mechanical difficulties in manufacture and assembly, conducting current more efficiently and eliminating serial sealing problems. The present invention of modular, integrated units provides such improvements for a fuel cell.

In particular, the present fuel cell comprises:

1. a single flexible or ridged bipolar separator plate;.

2. a flexible membrane electrode assembly;

3. a flexible bond or seal interposed between said flexible or ridged separator plate and said flexible membrane electrode assembly wherein said flexible bond or seal is or is not an adhesive bond or seal which encapsulates edge portions of said flexible or ridged separator plate and said flexible membrane electrode assembly;

4. a manifold for the delivery and removal of reactants and reactant products to and from the fuel cell reactive areas where said manifold is either a single or multiple manifolds; and/or (optionally)

5. a bond interposed between said manifold and said flexible or ridged separator plate, wherein said bond affixes said manifold to said flexible or ridged separator plate and wherein said bond provides a seal between said manifold and said flexible or ridged separator plate to prevent the release of reactants from the fuel cell.

In one embodiment the membrane electrode assembly has within it incorporated or bonded reactant diffusion layers as a single assembly.

In another embodiment the membrane electrode assembly is independent from the reactant diffusion layers.

In another embodiment in the fuel cell the flexible adhesive bond incorporates a gasket having adhesive on one side, on both sides or on neither side. This gasket material is comprised of a single one-component material or a composite material composed of two or more components. The gasket material is formed as a separate component or is formed on the surface of the separator plate or on the membrane electrode assembly.

In another embodiment the adhesive bond is solely an adhesive without the use of a gasket that is either applied to the separator plate or to the membrane electrode assembly or to both.

In another embodiment of the gasket material is in the form of a foam composed of a single one-component material or a composite material composed of two or more components with or without an incorporated adhesive.

In another embodiment the adhesive is applied directly to the bipolar separator plate before placing and adhering the membrane electrode assembly to the bipolar separator plate. The adhesive functions as a sealant to confine the reactants and as a fixative for securing the membrane electrode assembly to the separator plate.

In another embodiment the sealing of the gasket is supported by the bending, rolling or crimping of the edge of the flexible or ridged bipolar separator plate.

In another embodiment the sealing of the gasket is supported by the clamping of the edge of the flexible or ridged bipolar separator plate with auxiliary material which causes the same effect of bending, rolling or crimping the edge for the flexible or ridged bipolar separator plate.

In addition, assembled and tested modular cells clearly show measurable consistency between cells. Even with a hand assembly technique, nineteen demonstrated non-leaking cells operating as an ambient air natural convection stack system at 25 mA/cm² showed a variation within 5% of the average cell voltage for the stack.

The embodiments of the present invention differ considerably from U.S. Pat. No. 6,080,503 in as much as the present invention pertains to a single separator plate bonded to a single membrane electrode assembly as opposed to the conventional art teaching of two separator plates bonded to each side of a single membrane electrode assembly. The manufacturing improvement and increase in efficiency of these components is readily apparent.

The present invention also concerns an array of compliant electrical contacts.

In another aspect the array of compliant electrical contacts are in the form of a plurality of inverted V, Z, S, C- or omega shaped independent metal springs which are electrically, mechanically, metallurgically or combinations thereof contacted and connected to a conducting base plate or BSP.

In another aspect of the array of compliant electrical contacts, each spring contacts the MEA of the next cell of the fuel cell stack. This contact area can be point contact, line contact or preferably flat area contact. Contact area of the flat spring surface areas on the adjacent MEA can range from less than about 1% to more than 99% preferably in the range between about 30 to 90% more preferably between about 60 and 90%.

In another aspect the plurality of metal springs have a regular patterned arrangement having substantially uniform distance between contact points or surfaces.

In another aspect, the plurality of metal springs have an irregular patterned arrangement and substantially non uniform distance between contact points or surfaces.

In another aspect, the array of compliant electrical contacts are in the form of a plurality of small metal pins which are electrically and mechanically contacted to a conducting base plate.

In another aspect, the tips of the small metal pins which are in to contact with the adjacent electrode have a head similar to a nail head.

In another aspect, in the array the plurality of metal pins form an irregular arrangement or a regular patterned arrangement having a substantially uniform distance between pins.

In another aspect, the compliant electrical contacts are comprised of alloys of iron, copper, gold, silver, platinum, aluminum, nickel, chromium, and combinations thereof.

The present invention concerns an improved method to produce electrical energy using the fuel cells described.

### BRIEF DESCRIPTION OF THE FIGURES

FIG. 1 is a schematic representation of the basic conventional fuel cell process. It shows the extracted hydrogen ions which combine with oxygen across a PEM membrane to produce electrical power.

FIG. 2 is a schematic representation of the conventional PEM fuel cell stack of electrodes compressed together with heavy end plates and tie rod bolts.

FIG. 3 is a schematic representation of an exploded view of a conventional PEM single cell of a conventional fuel cell assembly.

FIG. 4 is a schematic representation of an exploded view of a conventional PEM fuel cell stack of electrodes showing the arrangement of the internal and external parts.

FIG. 4A is a schematic representation of the compliant electrical contacts with the array of cantilevered inverted V-shaped thin metal spring.

FIG. 4B is a schematic cross-section representation of the compliant electrical contacts with the array of cantilevered inverted V-shaped springs shown contacting the adjacent MEA.

FIG. 5A is a schematic representation of the obverse side of the integrated and modular bipolar separator plate (BSP), membrane electrode assembly (MEA) and two manifolds having a plane 5D-5D as a cut away.

FIG. 5B is the reverse side of the components described in FIG. 5A.

FIG. 5C is a schematic representation of reverse of an integrated and modular bipolar separator plate showing an alternate, vertical, arrangement of the compliant contacts.

FIG. 5D is a schematic cross-sectional representation of a section through the present fuel cell design and the relationship between the MEA BSP and the springs on the backside of the BSP along plane 5D-5D of FIG. 5A.

FIG. 6 is a exploded schematic representation of the integrated BSP, MEA, gaskets and manifolds.

FIG. 7 is a photographic representation of the compliant electrical contacts and array of inverted V-shaped cantilevered springs.

FIGS. 7A and 7B are detailed schematic representations of the integrated and modular cell assembly showing manifold and MEA attachments.

FIGS. 7C through 7H are detailed schematic representations of the integrated and modular cell assemblies in planar sections, which show the inner details of the manifolds.

FIG. 7C is a schematic representation of the manifold of FIG. 7B showing various planes A-A, B-B, C-C, and D-D cutting the manifold to show detail.

FIG. 7D is a schematic representation of the manifold of FIG. 7C cut along plane A-A.

FIG. 7E is a schematic representation of the manifold of FIG. 7C cut along plane B-B.

FIG. 7F is a schematic representation of the manifold of FIG. 7C cut along plane C-C.

FIG. 7G is a schematic representation of the manifold of FIG. 7C cut along planes B-B and C-C.

FIG. 7H is a schematic representation of the manifold of FIG. 7C cut along plane D-D, FIG. 8 is a photographic representation of an end view of the compliant electrical contacts of FIG. 7.

FIGS. 9A, 9B, 9C, 9D, 9E, 9F, 9G, 9H, 91, 9J, 9K, 9L, 9M, 9N, 9O and 9P are each schematic or isometric or cross sectional representations of various types of compliant electrical contacts. In all cases, regardless of spring shape, the contact areas of the springs maximize the physical surface contact and correct contact pressure to the MEA and facilitate electrical conduction and reduce electrical resistance.

FIG. 9A is an inverted V-shape. FIG. 9B is a circular portion of an arc. FIG. 9C is a right angle contact. FIG. 9D is a rounded inverted V-shape. FIG. 9E is an omega shape, with multiple deflection areas and multiple contact areas. FIG. 9F is an array of the omega shape in strip form. FIG. 9G is a “S” shape with a right angle contact. FIG. 9H is in an S shape in strip form. FIG. 91 is in an S shape with a radiused contact point and interlocking and alignment/locating features. FIG. 9J is an S with interlocking and locating features, in strip form. FIG. 9K is a Z form with right angle flat contact area. FIG. 9L is a Z shape in strip form. FIG. 9M is a modified omega shape similar to FIG. 9E having the support feet pointing outward. FIG. 9N has the support feet pointing inward.

FIG. 9O is a modified omega design, similar to FIG. 9E, without the crown or point in the top arch.

FIG. 9P is another design with a “C” shaped cross-section in strip form, which eliminates several of the bends of the omega shape and provides for ease of manufacture and more contact area per spring finger.

FIG. 10 is a schematic cross sectional representation of the “bed of nails” as the compliant electrical contacts. The array of contact points (48) contact the adjacent MEA.

FIG. 10A is an isometric schematic representation of the “bed of nails” as the compliant contacts with one manifold.

FIG. 11 is a photograph of the current embodiment showing the array of the modified omega design of FIG. 9O attached to the bipolar separator plate and with the multi manifold arrangement.

FIG. 12 is an edge view photograph of the spring/plate/manifold configuration shown in FIG. 11. This shows the array of springs attached to the bipolar separator plate.

FIG. 13 is an edge view photograph which shows an uncompressed stack of bipolar separator plates, manifolds and springs.

FIG. 14 is an edge view photograph which shows the same parts as in FIG. 13 in the compressed state with the springs making contact with the adjacent cell.

FIGS. 15A, 15B and 15C are schematic representations of the integrated and modular cell components and assembly having a single manifold of the present invention.

FIGS. 16A, 16B, 16C and 16D are schematic representations of a thin metal bipolar separator plates before (16A) and after (16B) crimping or rolling of the edges to support the MEA. FIGS. 16C and 16D are closer details of the schematic representation of 16A and 16B.

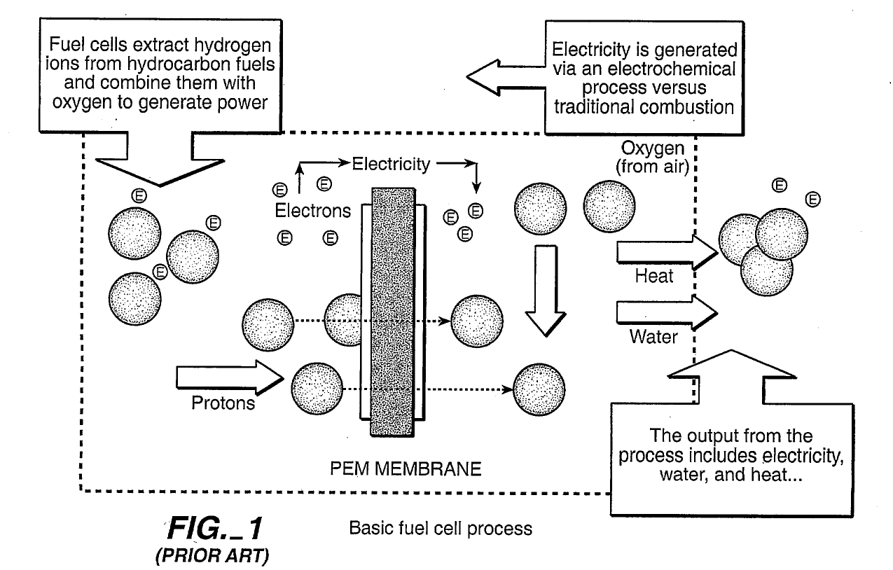

### DETAILED DESCRIPTION OF THE INVENTION AND PREFERRED EMBODIMENTS

Definitions:

As described herein:

“Bed of nails” refers to a configuration of compliant electrode contacts of vertical thin metal rods which accommodate forces and loads in an operating fuel cell usually the top (exposed) end of the rod is larger than the shaft (for better electrical contact).

“BSP” refers to bipolar separator plates which term is conventional in the art.

“Compliant electrode contact” refers to a spring-like adjusting electrical contact which create the loads and pressures of an operating fuel cell which maintain constant electrical contact.

“Flexible” refers to the BSP and/or MEA ability to flex with the forces and pressures of operation. The bonds between the components are substantially leak free. This flexibility assures that electrical contact and pressure or force is maintained by the compliant contacts as described herein.

“Manifold” refers to components affixed to the BSP for the delivery and removal of reactants and or coolant and or other materials from the fuel cell.

“Materials of construction” refers to the conventional materials that one of skill in the art would normally select to produce a conventional fuel cell. Unless otherwise noted herein for the present invention, conventional materials of construction are used.

“MEA” refers to the membrane electrode assembly—a component of a PEM fuel cell.

“Module” refers to identical single interchangeable separable components containing the bipolar separator plate, membrane electrode assembly, separate diffusion layers (if used), gaskets (if used), manifolds, adhesives, and seals (if used) and comprises a single electrochemical cell.

“PEM” refers to proton exchange membrane.

“Uniform thermal gradient” refers to gradual temperature changes across the BSP and MEA without temperature discontinuities or “hot sports” within the electrochemically active area.

Other definitions and terms used in the fuel cell art are exemplified as used in the patents and articles which are cited above and incorporated by reference herein.

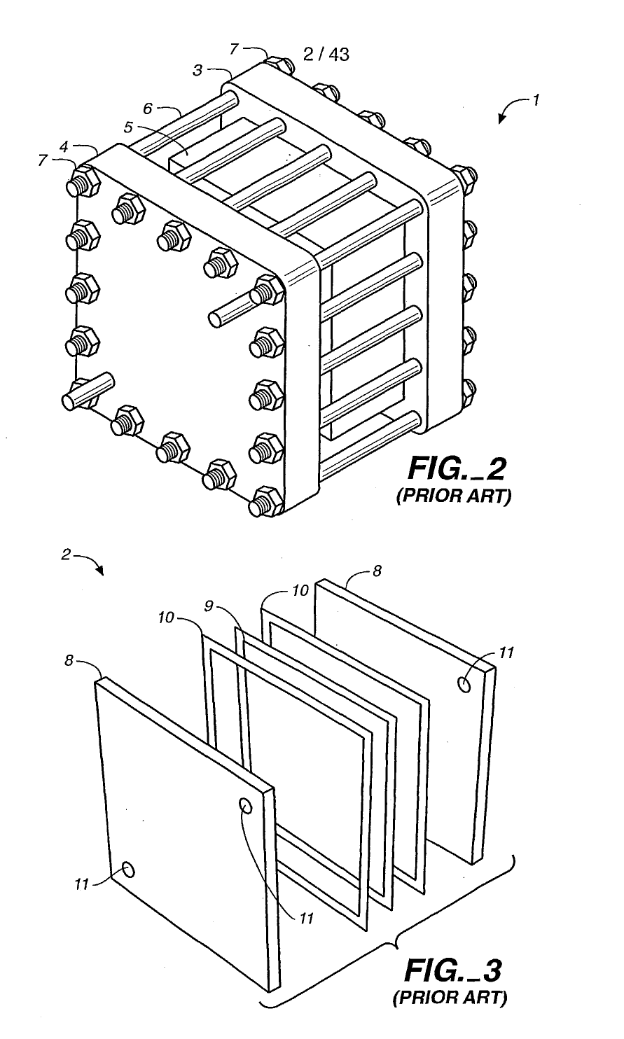

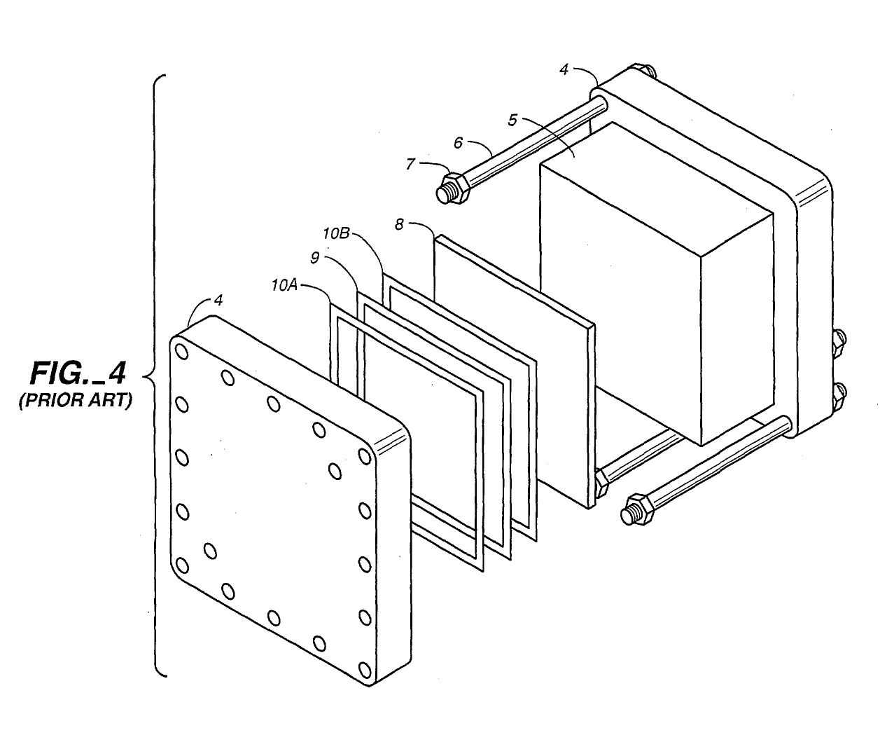

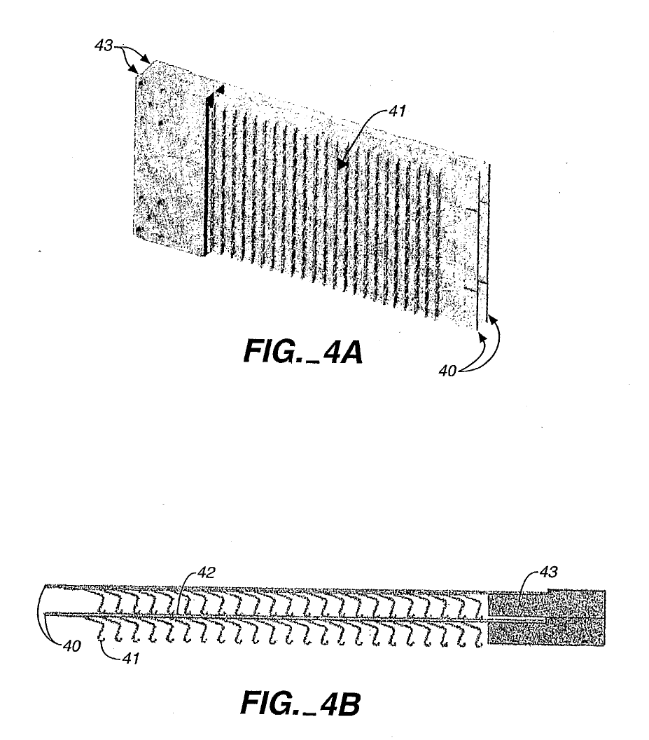

As stated above, traditional fuel cell design has relied on the “filter press” type of fabrication and assembly, see FIGS. 2, 3 and 4, i.e., end-plates and tie-rods, to create suitable electrical contact between the MEA and adjacent BSP, see FIG. 3. In the conventional fuel cell art, all the BSPs and MEAs must be assembled concurrently during the assembly of the fuel cell stack, see FIG. 4. This assembly method requires that all manifold and membrane sealing as well as electrical contact be accomplished at once when the stack of cells is in final assembly. If there is leakage or poor electrical contact in a single cell, then all the cells of the stack must be disassembled for remediation. While there are other assembly methods used in the fabrication of fuel cell stacks, none use a true modular approach to fuel cell assembly. This is the case for U. S. Pat. No. 6,080,503 wherein in the conventional art, a single MEA is “adhesively bonded to a pair of separator plates.” While the language of this issued patent uses the term “module,” these are not true single cell modules. They are better described as one and a half cell subassemblies, which are then combined into a stack and “compressed between two end plates in order to maintain proper electrical plate-to-plate contact between two adjacent modules.” This is nothing more than preassembling portions of the stack beforehand and then assembling them in the conventional inefficient bulky filter press method of assembly.

Compliant Electrical Contacts

In one embodiment, the compliant contacts are an array of individual metal strips which have been folded to produce an inverted V configuration. This is shown in FIGS. 4A, 4B, 7-8 and 9D. One side of the inverted V-shape is connected mechanically and electrically to a conducting base. The points of the inverted V spring 41 configuration provide electrical and mechanical contact to the MEA 42. As each individual folded strip contacts the electrode, it adjusts to the variation in cell spacing as determined by the reactant manifolds 43 and maintains uniform electrical contact with the MEA 42.

As stated above, traditional fuel cell design has relied on the “filter press” type of fabrication and assembly, see FIGS. 2, 3 and 4, i.e., end-plates and tie-rods, to create suitable electrical contact between the MEA and adjacent BSP. These designs have not made use of other, more standardized forms of electrical contact such as (1) metallurgical, by methods such as welding, soldering or brazing, (2) mechanically such as fastened with bolts, screws, cams, etc., and (3) spring contacts such as battery clips or wall plugs. As a method of decoupling the electrical contacts from the external force, spring loaded electrical contacts of the present invention are a novel solution and add mechanical compliance.

The present fuel cell uses thin metal plate BSPs in which the reactant gas flow patterns are integrated. Each BSP is independently held in intimate contact with the MEA via independent acting compliant spring electrical contacts and do not require the heavy end plates, tie rods and the massive compressive forces required of traditional fuel cell stacks to achieve contact and conductance.

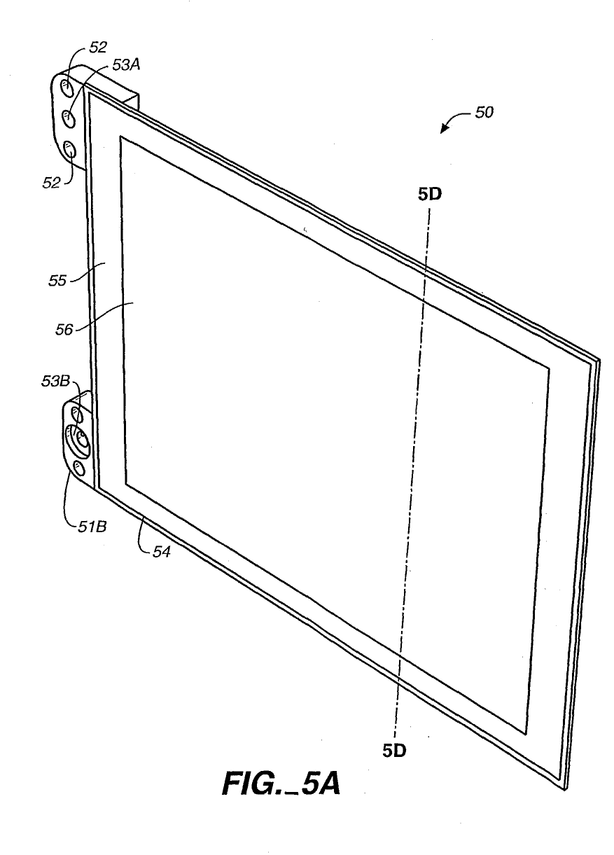

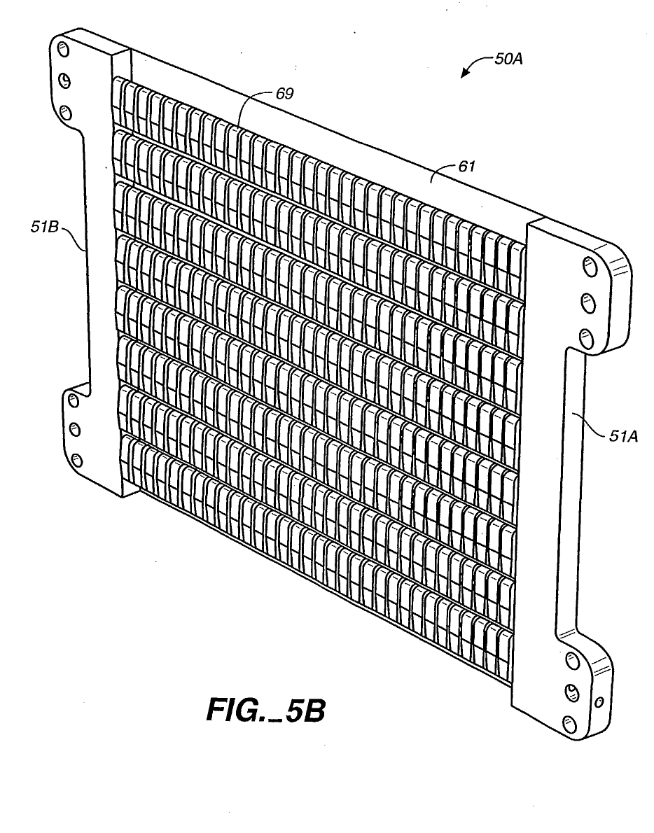

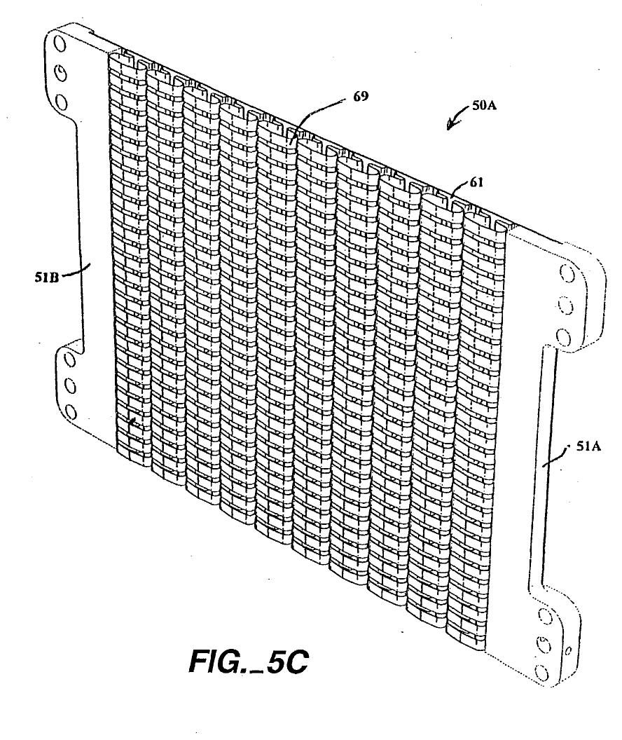

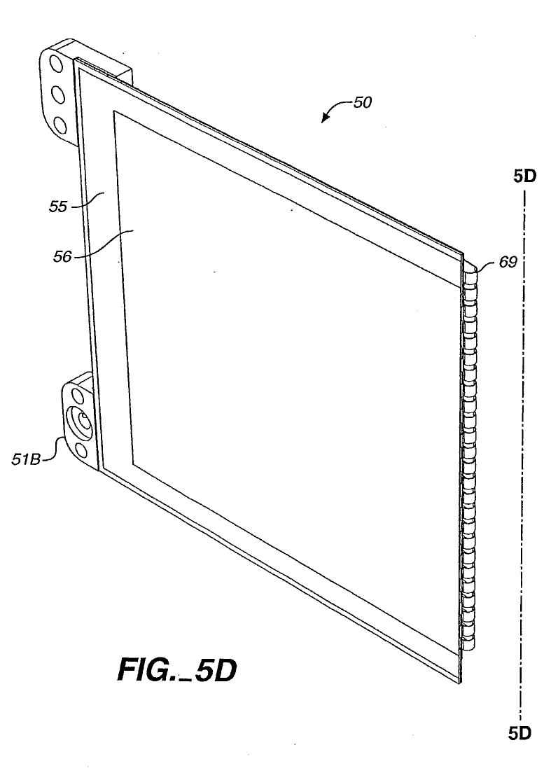

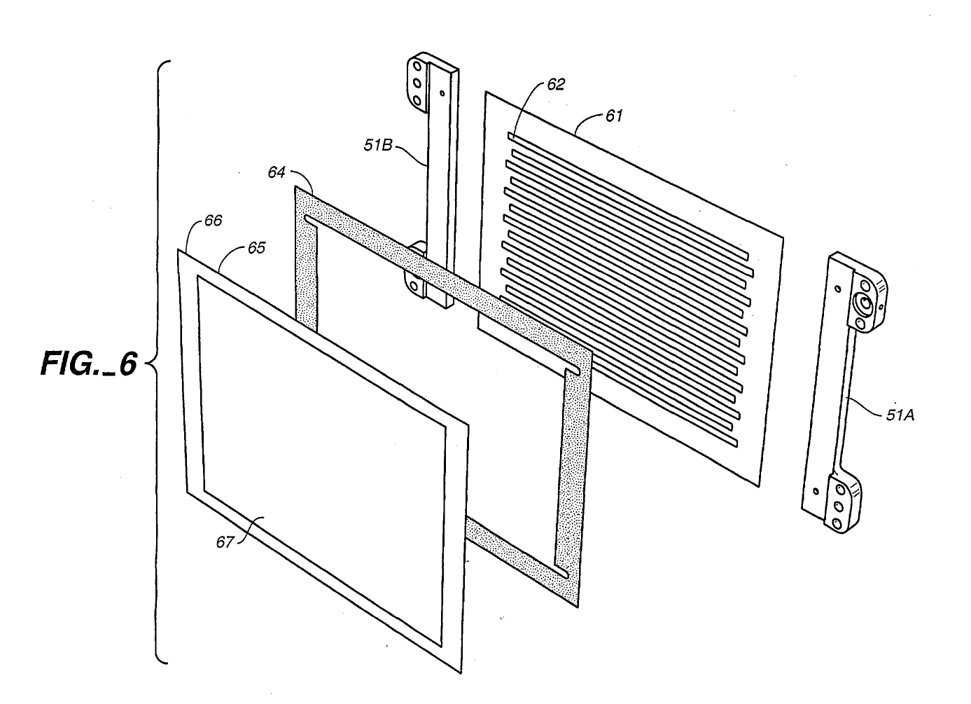

Conventional fuel cell design is followed up to a certain point in this invention. See for example U.S. Pat. No. 6,030,718 and the other U.S. patents listed herein. One of skill in the art with these incorporated-by-reference U.S. patents will have the basic design to fabricate a conventional fuel cell. With the text and figures provided herein, one of skill in the art is enabled to fabricate the present invention. In the creation of the compliant electrical contacts of the present invention within the cell, the following additional methodology is followed. With reference to FIGS. 5A through 6 the present fuel cell design 50 uses a single thin metal plate BSP onto which the MEA and reactant manifolds 51A, 51B, 5ID and FIG. 6 are assembled into modular units prior to being incorporated into a complete fuel cell unit (stack). These fuel cell modules are comprised of a single BSP 61, which may contain a reactant flow pattern, the MEA 65 with or without an incorporated diffusion layer, separate diffusion layers if needed, an adhesive or an adhesive backed gasket, the reactant manifolds 51A and 51B and the manifold seals or adhesives. Other features in Figure SA include on the obverse adhesive or gasket by the hole 52, reactant passageway 53, 53A and 53B, edge seal 54, inactive border 55 and active membrane 56.

Compliant electrical contact is achieved in the subject fuel cell design by use of springs and contact points. In the spring design a large array of individual springs are attached to each BSP each of which makes intimate contact with the MEA attached to the adjacent BSP, see FIGS. 4A, 4B, 7 and 8. When these springs are compressed, continuous electrical contact is assured between the adjacent BSPs through the MEAs, FIGS. 5A and 6. FIGS. 4A, 4B, 7 and 8 are photographs of one array of inverted V-shaped compliant electrical contacts.

The compliant electrical contacts can take a number of forms. All units are flexible. For example, FIGS. 4A, 4B, 7, 8 and 9D show a rounded contact point which is in an inverted V-shape. Other shapes include the following:

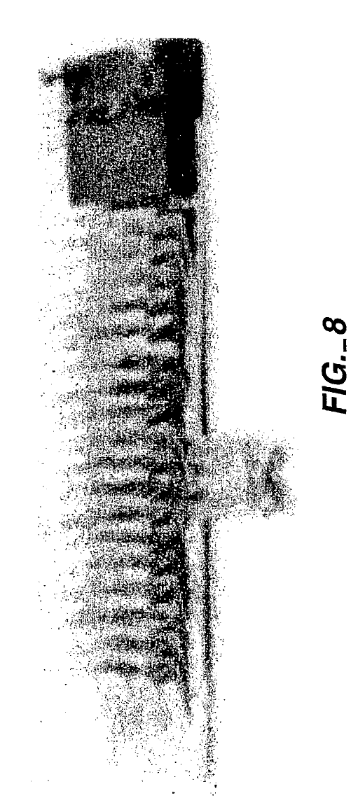

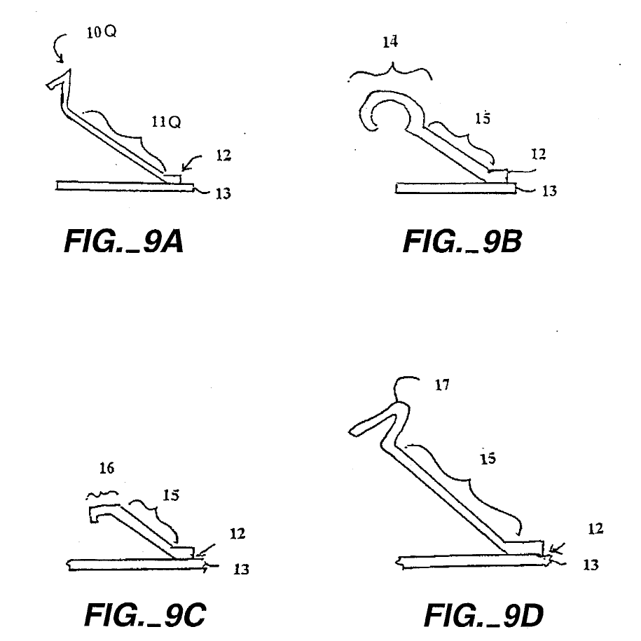

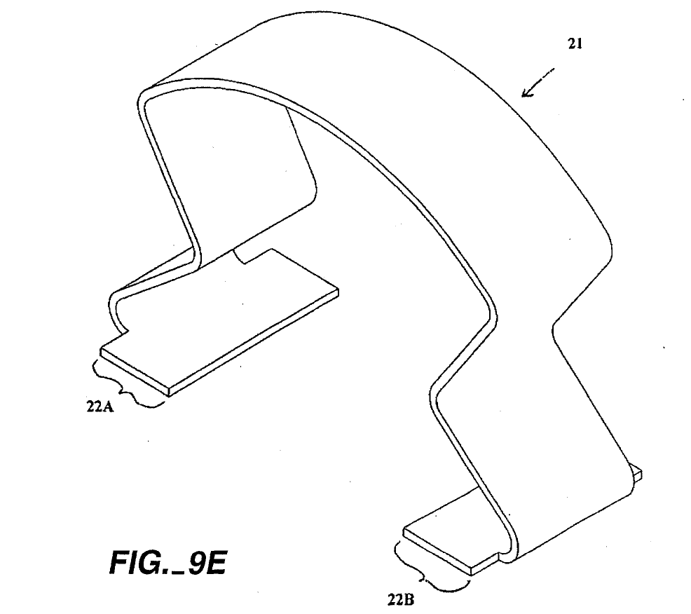

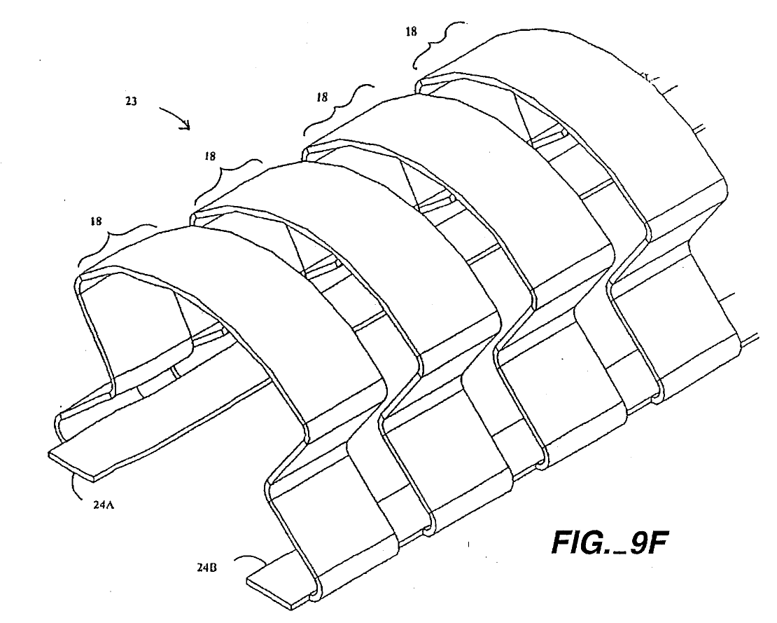

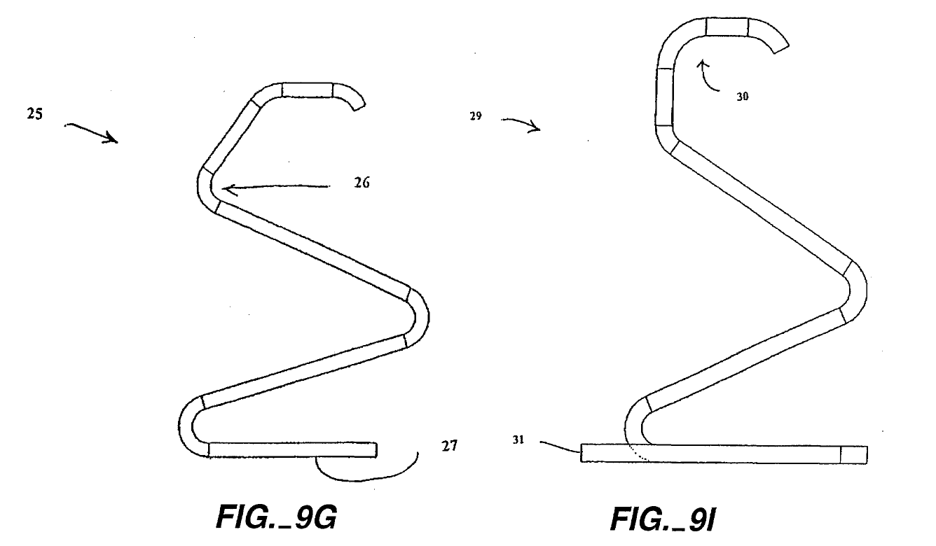

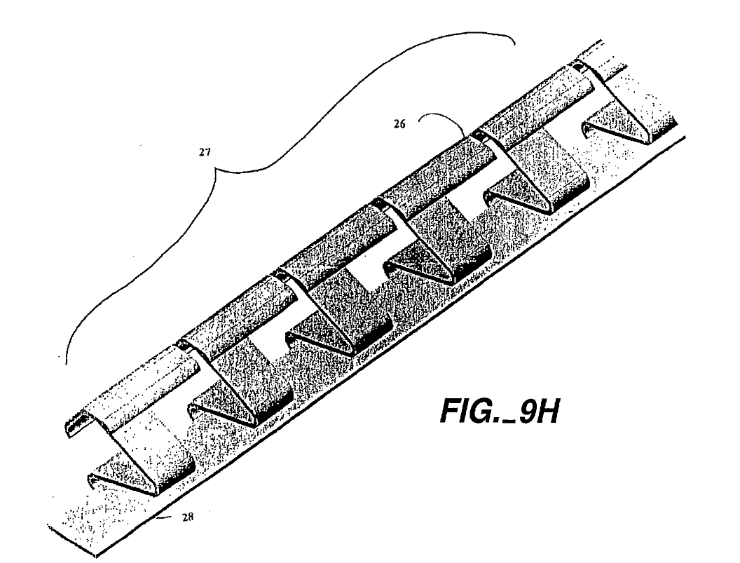

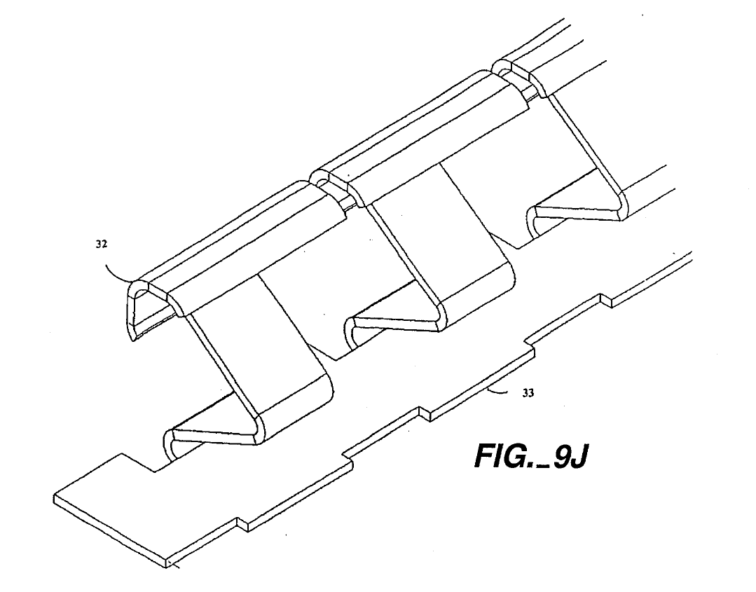

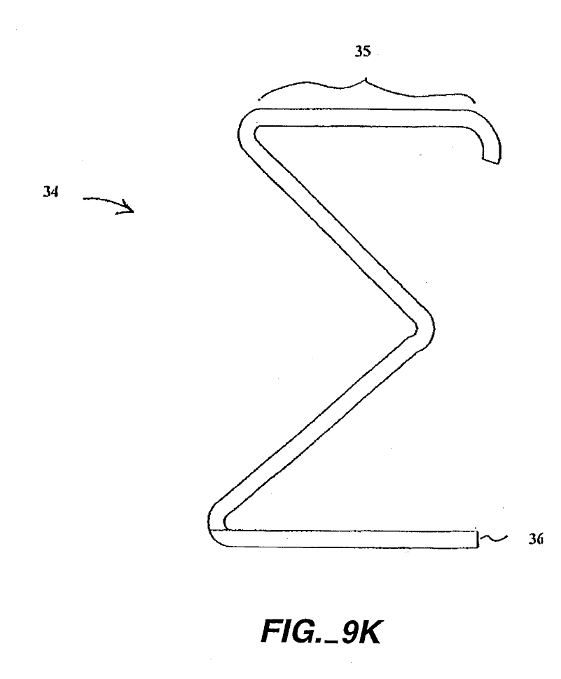

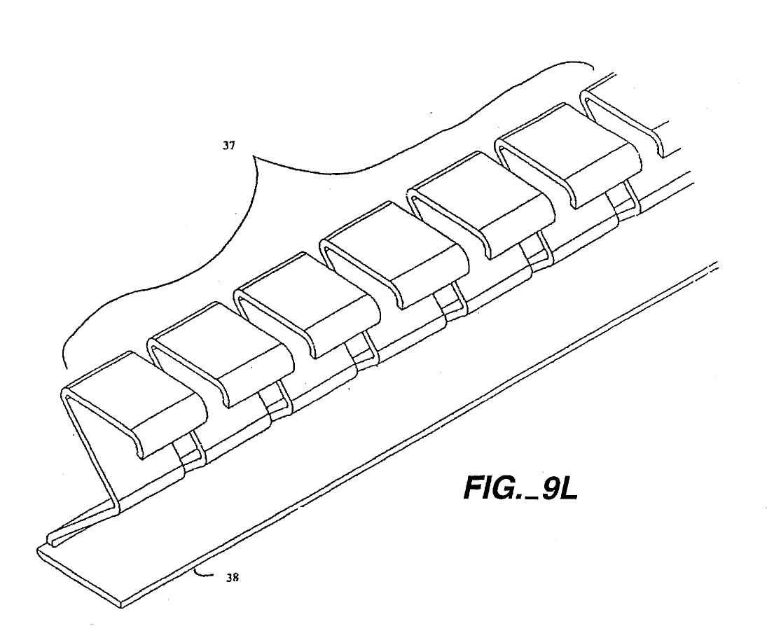

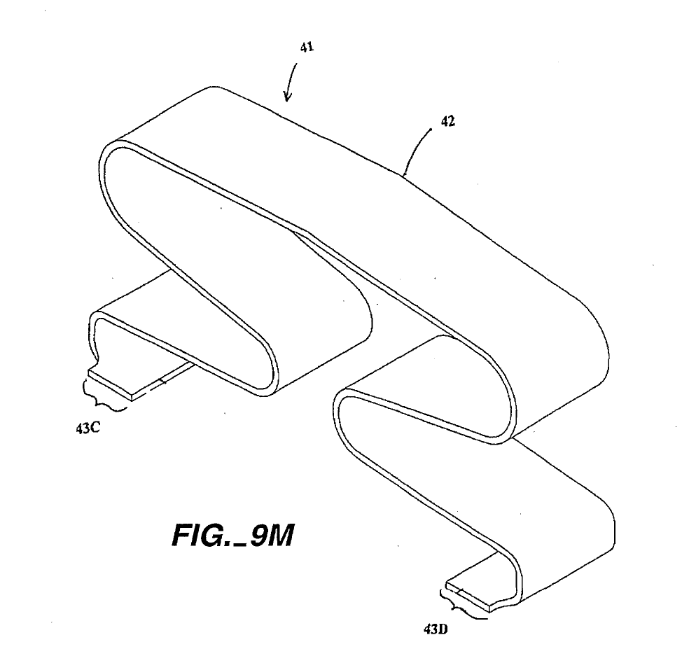

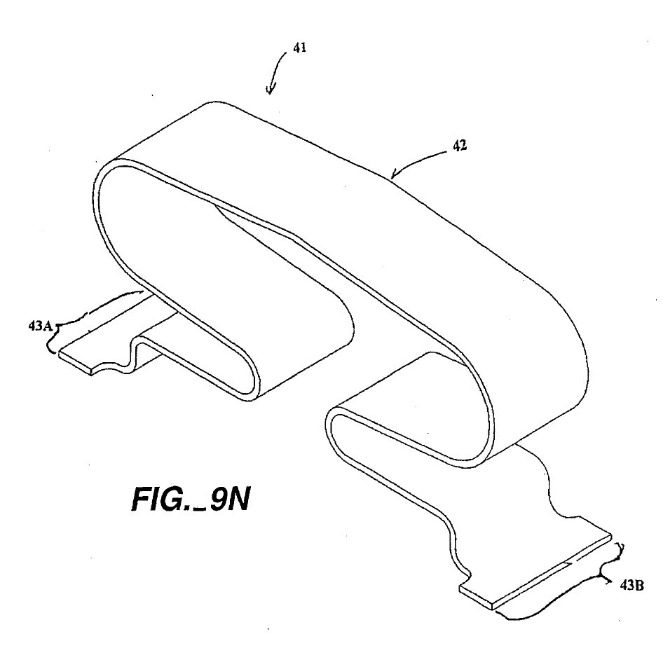

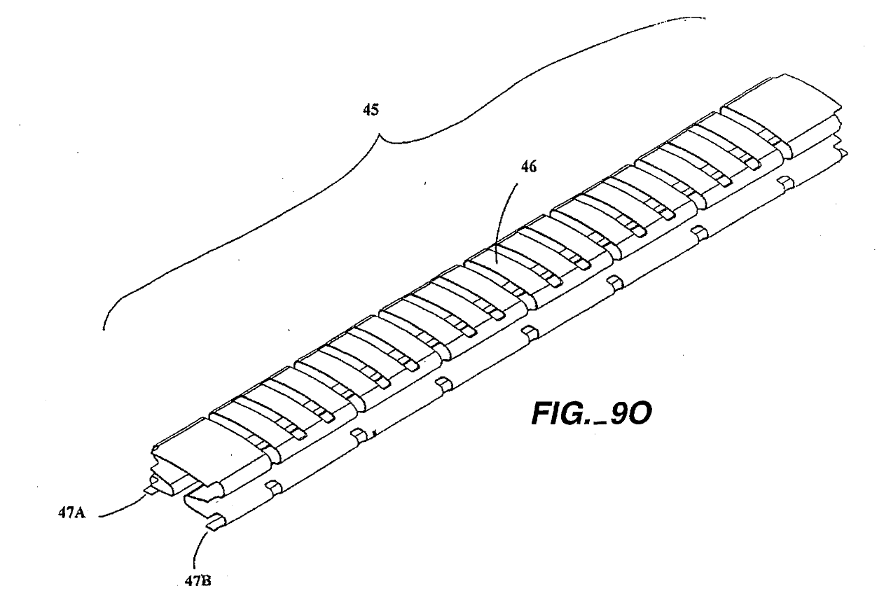

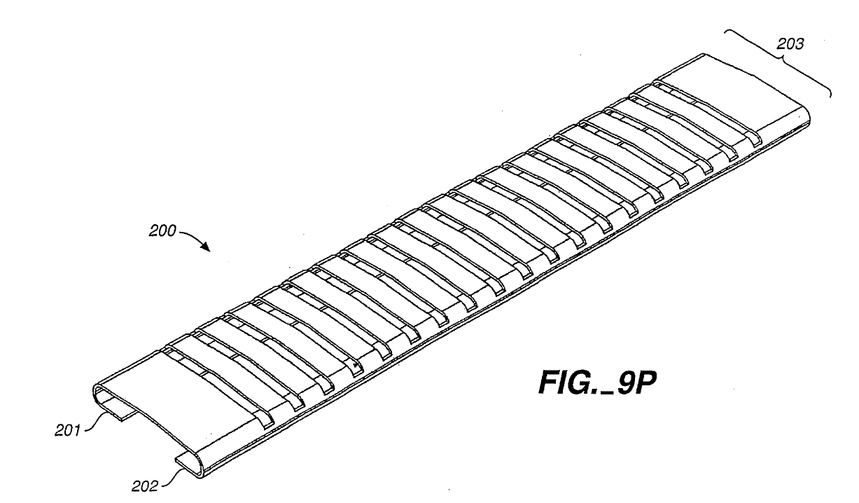

FIG. 9A which shows a sharp inverted V-shape 10Q having a cantilevered portion 11 Q which is mechanically contacted at area 12 to a base plate 13.

FIG. 9B shows a round metal arc 14 as contact having a cantilevered portion 15 which is contacted at area 12 to a base plate 13.

FIG. 9C shows a flat surface 16 as the contact having a cantilevered portion 15 which is contacted at area 12 to base plate 13.

FIG. 9D shows a rounded, inverted “V” form 17 having a cantilevered portion 15 which is contacted at area 12 to base plate 13.

FIG. 9E shows a modified omega shape 21, with multiple deflection areas and multiple contact areas. One or both flat portions 22A and 22B are connected to a base plate.

FIG. 9F is an array 23 of the modified omega shape in strip form 18 which are connected to the base plate 24A and 24B.

FIG. 9G is a “S” shape 25 with right angle contact 26 having a flat area 27 to connect to a base plate.

FIG. 9H is an array of “S”-shape 26 of FIG. 9G, wherein the array of S-shape contacts are connected to a base plate 28.

FIG. 91 is a “S” shape 29 with radiused contact point 30 and interlocking and alignment/locating features. The “S” shape is connected to base 31.

FIG. 9J is an array of the S-shape 32 in strip form connected to base 33.

FIG. 9K is a “Z” form 34 with right angle (flat contact) contact area 35. The Z-shape is connected to a base 36.

FIG. 9L is an array 37 of the Z-shape (flat contact) of FIG. 9K which is connected to base 38.

FIG. 9M is a modified omega configuration similar to FIG. 9E has two versions. FIG. 9M with the support feet pointing inward and FIG. 9N with the support feet pointing outward. The modified omega has a slight break in the curve at the top 42. One or both flat portions 43A and 43B are mechanically (e.g. soldered) and electrically attached to a conducting base plate and can point either outward (43A and 43B) or inward (43C and 43D).

FIG. 9O is a modified omega configuration shown in an array 45 similar to FIGS. 9E and 9F. The modified omega has no break in the curve at the top 46. One or both flat portions 47A and 47B are mechanically and electrically attached to a conducting base plate.

FIG. 9P is the “C” section spring in an array (200). The design eliminates several of the bends of the omega configuration described herein. This spring array having a flat surface (203) is attached to the conducting plate in the same manner as the other springs at surfaces (201) and (202).

In all cases, regardless of spring shape, the contact areas of the springs maximize the physical contact and correct contact pressure to the MEA and facilitate electrical conduction, and reduce electrical resistance.

The compliant electrical contact approach (springs) is not limited by size or shape of the application. The springs are usually between 0.020 in. (0.05 cm) and 2 in. (5.08 cm) high. The forces (e.g. tension) in the spring portion, within the cell that are accommodated by the compliant electrical contacts is usually between about 0.10 lb and 50 lb per spring leaf depending on the configuration as described herein. For example, when the spring strip has a thickness of 0.004 in. (0.01 cm), and is deflected (compressed 0.040 in. (0.1 cm), 0.84 pounds force is created. The plates are as small as 0.25 (0.625 cm) in.×0.25 in. (0.625 cm) (for very small, light, portable devices such as video cameras, movie cameras, etc.) to the large sizes required for homes, businesses, large buildings, or even small cities.

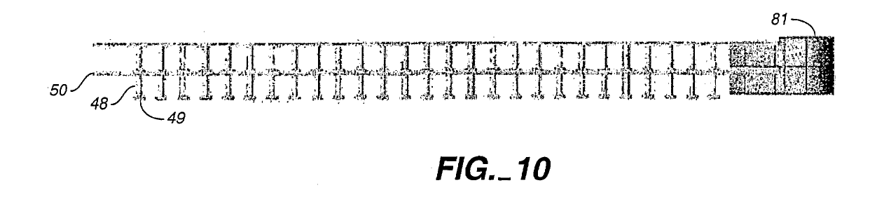

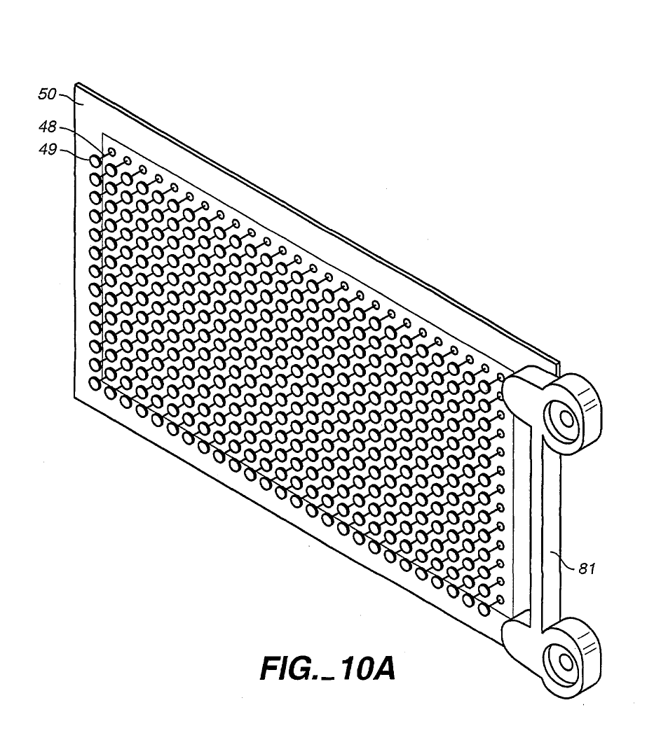

In the contact points design, very thin, very flexible metal BSPs (0.001-0.500 in. (0.025-1.27 cm thick) with numerous metal contact pins (48) with heads (49) which are optionally larger than the diameter of the pins are used to effect the contact, FIGS. 10 and 10A. Each pin is attached to the metal BSP (50). The head of the pin is the electrical contact surface and mechanical support for the adjacent MEA. The individual BSPs do not have springs. The springs are located on each end of the stack or in the center of the stack, pushing the thin flexible metal BSPs to create compliant electrical contacts.

These methods do not rely on perfectly flat BSPs and the heavy and bulky end-plates and tie-rods of the conventional fuel cell art.

In a preferred embodiment, a modified omega or “C” configuration, FIGS. 9O and 9P, compliant electrical contacts, in strip or array form 45, without crown or break at top 46, are orientated vertically on the thin metal conductive plate and bipolar separator plate. The contact portion of the 0.004 in. (0.001 cm) thick compliant contact (springs) has essentially flat surfaces that are approximately 0.100 in. (0.26 cm) by 0.400 in. (1 cm). Each compliant contact is separated from the other by 0.050 in. (1.25 cm). The strip or individual springs are approximately 0.200 in. (0.5 cm) high. Each individual contact exerts approximately 2.5 pounds (11.125 newton) of spring force, when compressed 0.030 (0.025 cm) to 0.040 (0.1 cm) in. in the fuel cell stack.

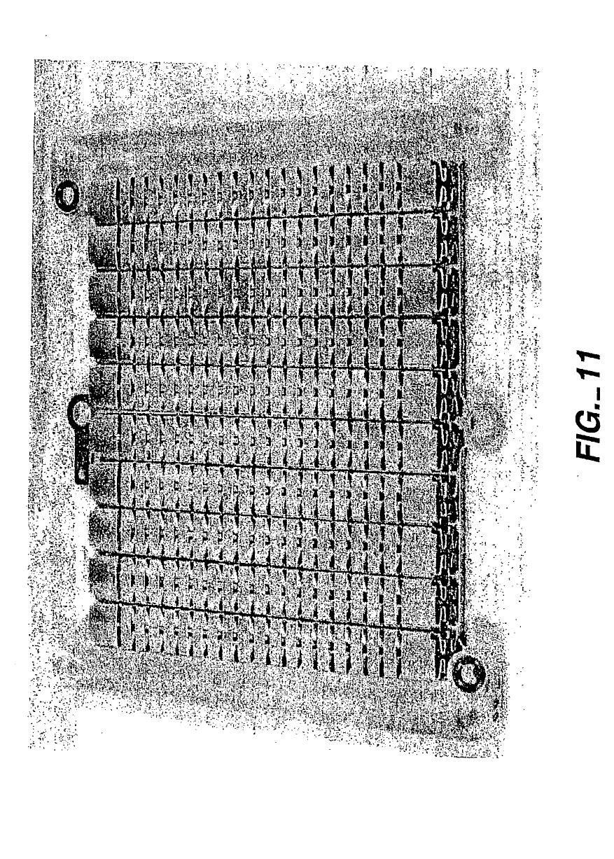

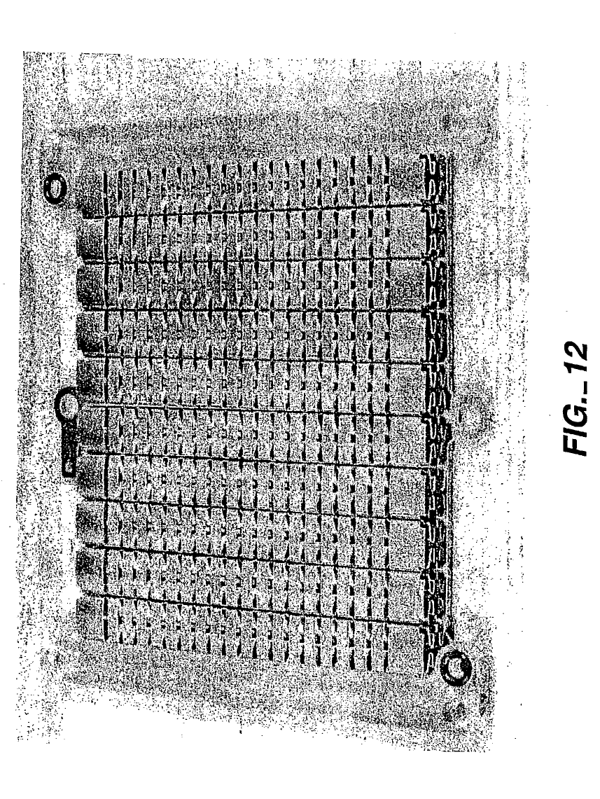

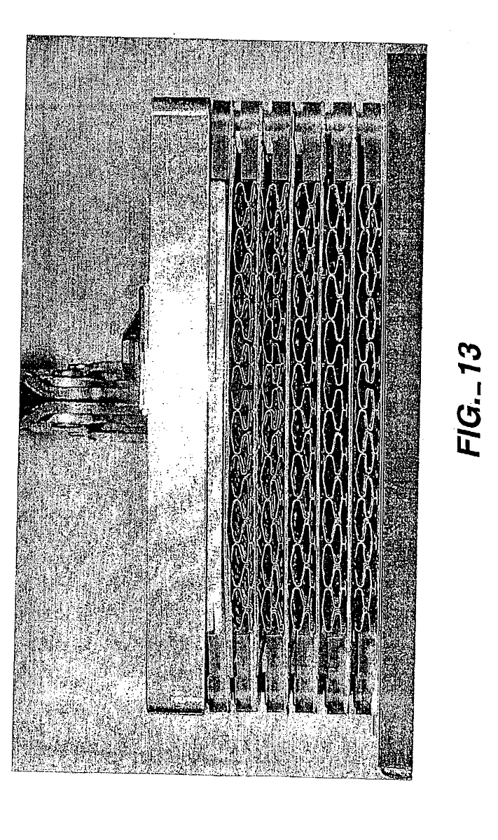

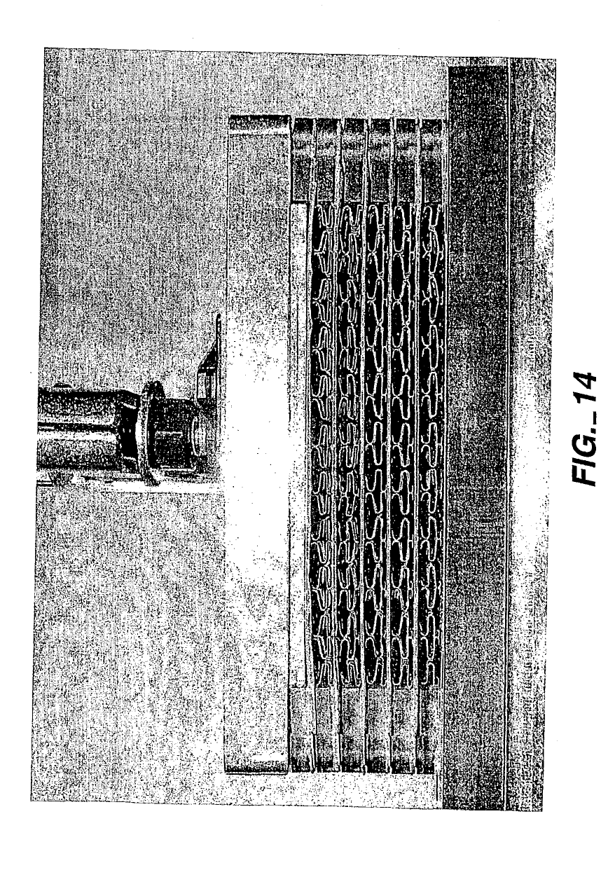

The one preferred embodiment, FIGS. 11 and 12, shows the array of FIG. 9N attached to the bipolar separator plate along with the attached manifolds. In the relaxed condition, the crowns of the spring contacts extend above the level of the manifolds. FIG. 13 shows a stack of the plates in the relaxed spring condition. When compressed, in FIG. 14, the spring arrays are compressed and the individual springs contact the neighboring cell with the result of a positive electrical contact with its neighbor. Each spring acts independently from the adjacent spring of the arrays and therefore compensates for any variation in fabrication or assembly.

A variety of materials are used for such contacts. Gold plate is the obvious choice due to its resistance to the high humidity atmosphere associated with fuel cell operation and its corrosion resistance. Spring-loaded contacts fabricated from stainless steel (without gold plating) or other alloys were used to demonstrate the technology with significant performance improvement over expected results.

The preferred method of fabrication is to stamp or coin the metal conducting plates, stamp the spring or compliant contact blank and form the compliant contact to shape by stamping. While these are the preferred methods, the metal conducting plates are formed by a wide variety of processes well known to those skilled in the art. The compliant contact(s) are then attached to the conducting plate via pre-applied solder paste and soldered using conventional electronic circuit board manufacturing equipment and techniques or they are welded using a variety of techniques well known to those skilled in the art. This embodiment provides a uniform thermal gradient, especially when the compliant electrical contacts are oriented vertically in the fuel cell stack. This configuration creates a chimney effect and increasing the amount of air (oxygen) to the membrane. The heated air, due to the chimney effect, carries the excess heat away. This is an usually desirable feature.

Integrated And Modular BSP/MMEA/Manifold Units

With reference to FIGS. 5A, 5B, 5C, 5D, 6, 7A, 7B, 7C, 7D, 7E, 7F, 7G and 7H, the present fuel cell design 50 uses a single thin metal plate BSP 61 onto which the MEA 65 and reactant manifolds 51 are assembled into modular units prior to being incorporated into a complete fuel cell unit (stack). These fuel cell modules are comprised of a single BSP 61, which may contain a reactant flow pattern 62, the MEA 65 with or without an incorporated diffusion layer 67, separate diffusion layers if needed, an adhesive 66 or an adhesive backed gasket 64, the reactant manifolds 51 and the manifold seals or adhesives 64A or 66.

Other features in FIGS. 5A, 5B, 5C, 5D, 6, 7A, 7B, 7C, 7D, 7E, 7F, 7G and 7H, include on the obverse an adhesive or gasket by the hole 52, reactant passageway 53, edge seal 54, inactive border 55 and active membrane 56. FIG. 5B in this orientation has improved control of heat

On the reverse side i.e. FIG. 5B, the features are the same as for FIG. 5A and further include the multiple arrays of horizontal compliant electrical contacts 69 as described herein. FIG. 5C shows an alternate arrangement of the vertical multiple arrays of compliant electrical contacts 69 as described herein.

FIGS. 5A and 5D show the present fuel cell design 50 with the location of plane 5D-5D to illustrate the relationships between the contact spring 69 and the MEA 56 as shown in FIGS. 5A, 5B and 5C.

In the modular cell stack assembly, the manifolds 51 and 51A contact the adjacent manifold of the next modular cell. The compliant electrical contacts 69 contact the active membrane 65 of the adjacent cell.

Conventional fuel cell design is followed up to a certain point. See teachings of U.S. Pat. No. 6,030,718 and other U.S. patents listed hereinabove. As is apparent to those skilled in the art, these incorporated-by-reference U. S. patents disclose a basic design to fabricate a conventional fuel cell. With the text and figures provided herein, those skilled in the art are enabled to fabricate the present invention. In the creation of the single cells integrated modules of the present invention, the following additional methodology is followed:

Conventional fuel cell designs are sealed around the edge of the BSP and the BSP to the MEA by the use of substantially non-adhesive inert gaskets. The pressure from the tie-rods and end-plates holds and seals the assembly in place.

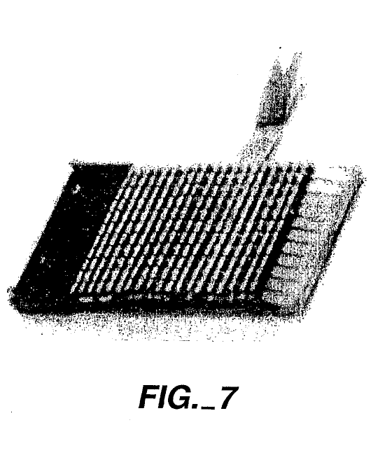

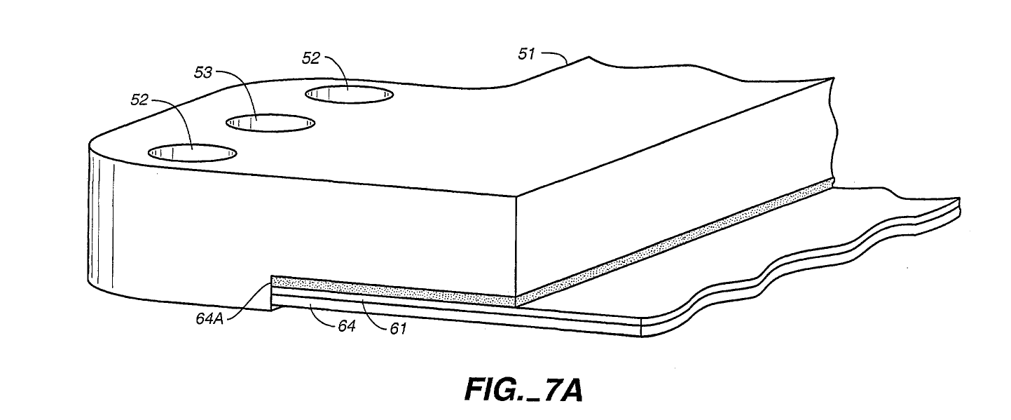

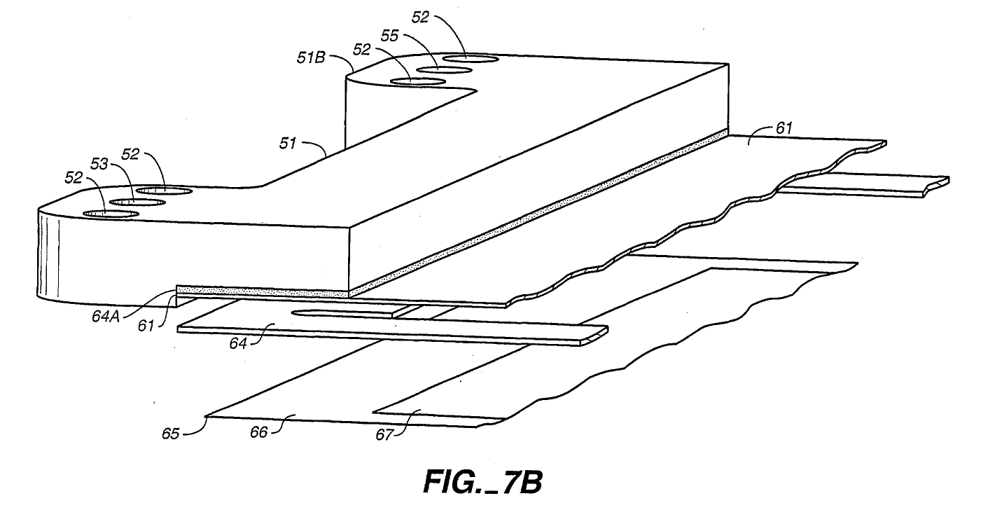

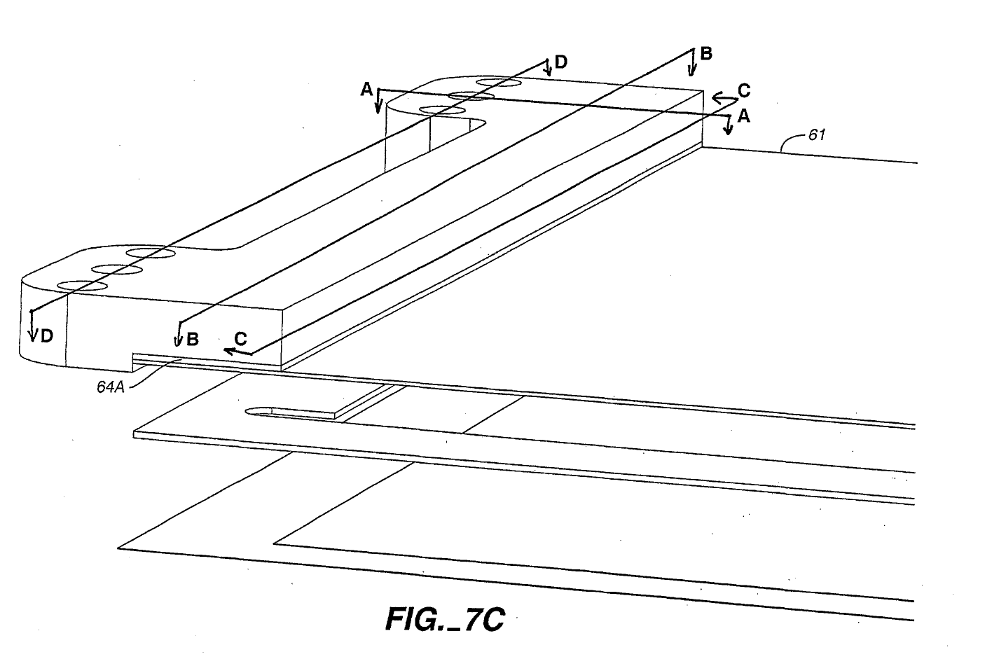

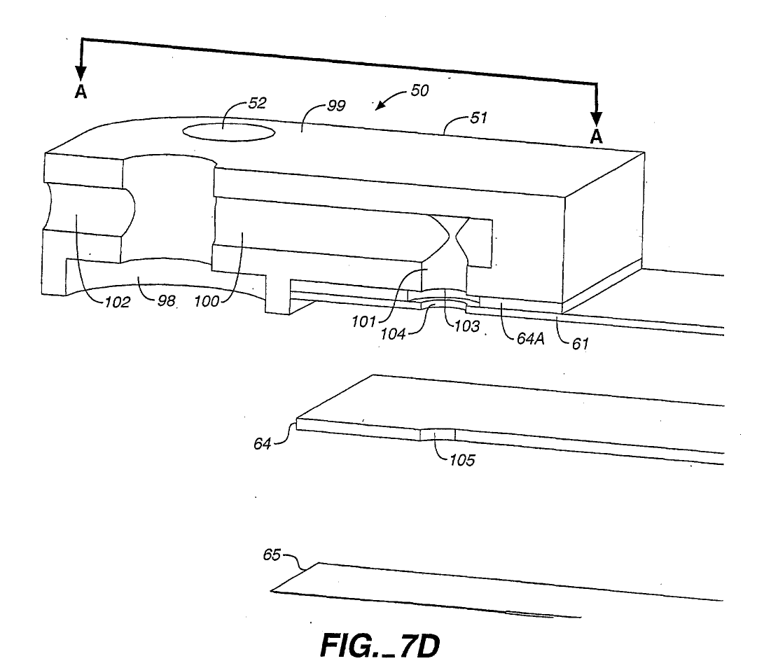

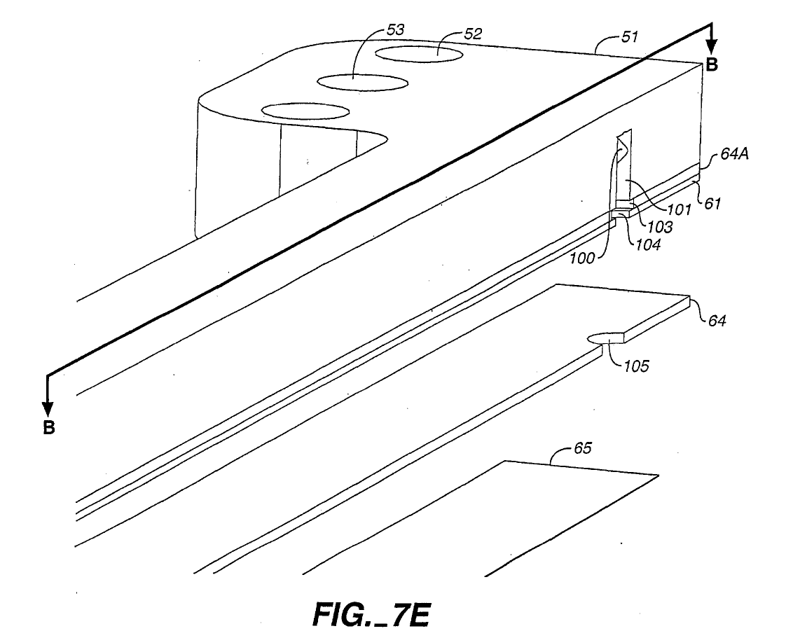

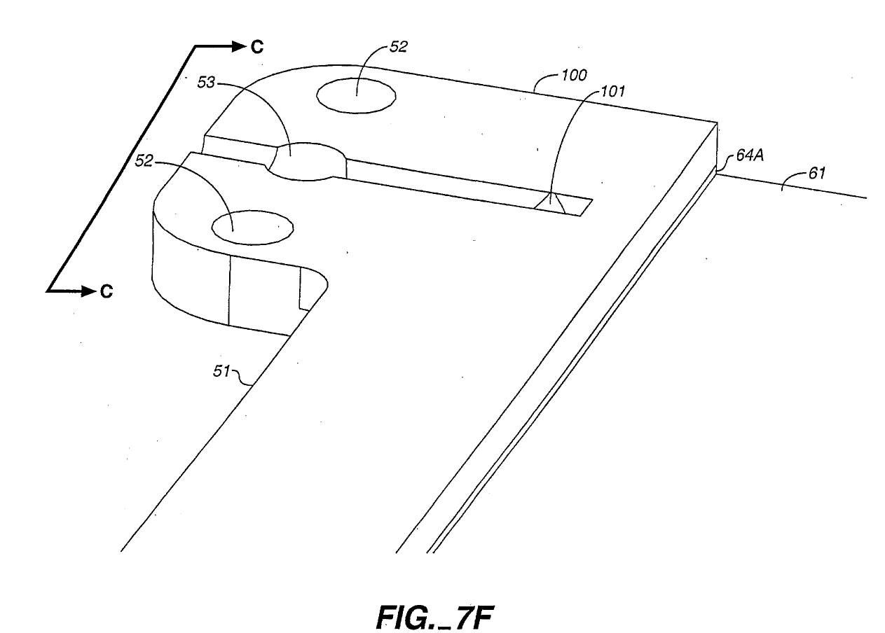

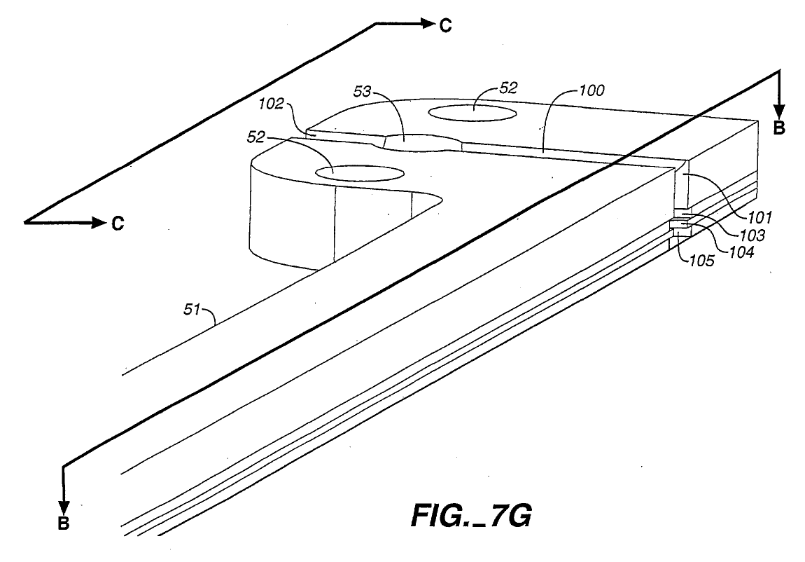

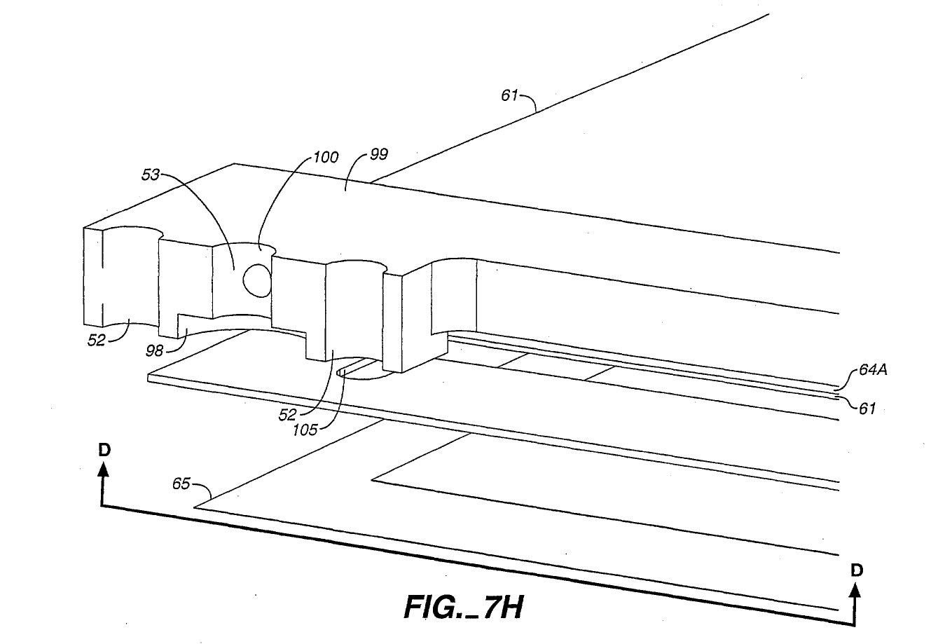

In contrast, the modular design shown in FIGS. 5A, 5B, 5C, 5D, 6, 7A, 7B, 7C, 7D, 7E, 7F, 7G, and 7H utilizes adhesives or gaskets with adhesive seals between the MEA 65 and single BSP 61. FIGS. 7A and 7B show an adhesive 66, with or without a carrier gasket 64, to bond the MEA 65 to the hydrogen side of the BSP 61. In addition, the reactant manifolds 51 are adhesively bonded 64A to the BSP 61 in a similar manner, as is the MEA 65.

FIG. 7C shows the location of planes B-B, C-C, D-D and E-E which are then represented in cross-section in FIGS. 7D through 7H. These planes and Figures in cross-sections reveal the inner features of the manifold 51 and illustrate how the hydrogen fuel is delivered, the reaction with oxygen occurs, and the excess reactants and other materials such as water, water vapor or other gases are removed from the modular fuel cell 50.

The planes A-A, B-B, C-C, and D-D are shown in FIGS. 7C, 7D, 7E, 7F, and 7H respectively while FIG. 7G shows a combination of planes C-C and D-D. These figures show the reactant passageway 53 through which the hydrogen gas is delivered to the fuel cell 50. As discussed herein, a plurality of these cells 50 are stacked together which interconnects the reactant passageways 53 to form a long reactant delivery tube. The manifolds 51 are sealed to one another by O-rings (not shown for clarity), which are placed in an O-ring groove 98 which then mates with the next identical cell 51 against sealing surface 99. Once the manifolds 51 are sealed together, the reactant (hydrogen) is delivered through reactant passage 53 and into the cross feed channel 100 to the reactant delivery port 101 and subsequent delivery into the active region of the cell. The short section of the cross feed channel 102 is in place for ease of fabrication and is not generally functional during the operation of the cell 50.

After reaching the delivery port 101 the reactant passes through a port 103 in the adhesive 64A that holds the manifold 51 to the BSP 61. The BSP 61 also has a port 104, which is concentric with the delivery port 101, and the port in the adhesive 103. The reactant continues and passes through an additional concentric port 105 in the adhesive backed gasket 64 (if and when used). The reactant hydrogen is then delivered to the anode side of the MEA 65 where the electrochemical reaction occurs.

The hydrogen reacts with oxygen (or the oxygen in air) at about ambient pressure or under pressures of the art such as between ambient and 1 psig (1.01×10⁴ Pa), 5 psig (13.5×10⁴ Pa), 30 psig (30.8×10⁴ Pa) , 424 psig (424×10⁴ Pa) or as much as 10,000 psig (6.9×10⁷ Pa). Hydrogen and oxygen or any oxygen containing gas stream, such as air, is introduced into the cell. The two gases are separated by and electrolyte contained within the MEA 65. Hydrogen is ionized to hydrogen ions and releases electrons. The hydrogen ions pass through the electrolyte and electrons take an external electrically conductive path to combine with the oxygen on the other side of the electrolyte to produce water. The electron flow transfers the electrical energy of the cell to a load.

After the electrochemical reaction has taken place or when the cells 50 require flushing or purging of the excess reactants and other materials such as water, water vapor or other impurity gases. These materials are removed from the cell 50 through a reverse of the entry process which is discussed above. For the purpose of this discussion it is assumed that there are two manifolds 51 as shown in FIG. 6. If the entry manifold is 51A, then the exit manifold is 51B for this example. The gases pass from the reaction area of the MEA 65 through the opening in the adhesive backed gasket 64 (if and when used) through the ports 104 and 103 in the BSP 61 and the adhesive 64A and into the delivery port 101. From the delivery port 101 the gases pass into the cross feed channel 100 and from there into the reactant passageway 53 through which it is exhausted to the environment. Since the product is essentially pure water and/or water vapor, this fuel cell operation is non-polluting

The manifolds 51 are external to the BSP 61 and the MEA 65. The MEA 65 does not have holes for manifold or gas passages. This feature eliminates the use of the MEA 65 as a through passage and, likewise eliminates any possible leakage due to a through passage through the membrane 67.

This new assembly process creates an integrated, leak proof fuel cell assembly. Each assembly is leaked tested and performance tested independently from the stack of the individual cells as is conventional in the art.

This novel method of assembly decouples the MEA sealing from the stack assembly, and compressive loads of the end-plates and tie-rods.

The individual components of the integrated and modular BSP/MEA separator plates for fuel cells are mass-produced and assembled into the integrated and modular BSP/MEA and tested independently off-line to increase the assurance that a functional stack of cells will be produced.

Additionally, since each module is an integrated, sealed unit, the stack is assembled and held together more simply than the traditional means of heavy end-plates and tie-rods required to maintain sealing and intimate contact between surfaces to effect electrical conductivity.

The manifold 81 on the integrated, modular BSPIMEA is of a single arrangement as shown in FIGS. 10A, 8A, 8B, and 8C or multiple manifolds of those shown in FIGS. 5A, 5B, 5C, 5D and 6. The manifolds 51A and 51B allow the delivery and exhausting of the reactants and reaction products respectively. In a multiple manifold configuration, FIGS. 5A, 5B, 5C, 5D and 6 show the reactants are delivered on one side by one manifold 51A and the reaction products exhausted on the other side by a different manifold 51B. In the single manifold 81 configuration, FIGS. 10A, 8A, 8B and 8C the reactants are delivered and exhausted by the single manifold 81.

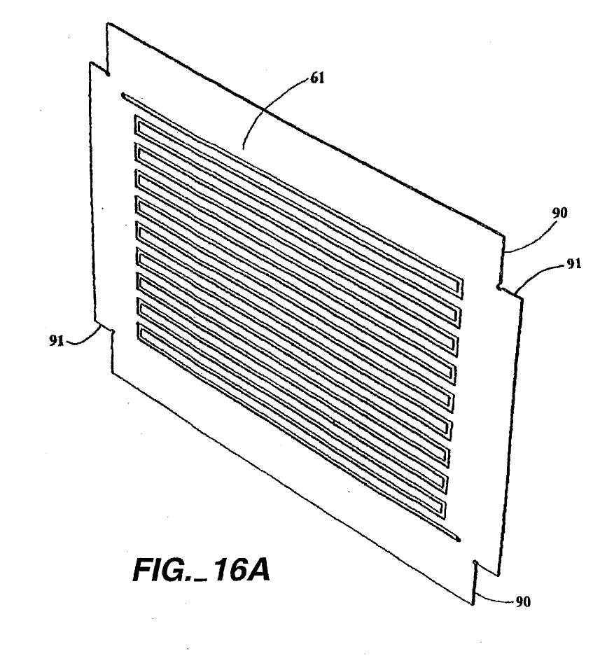

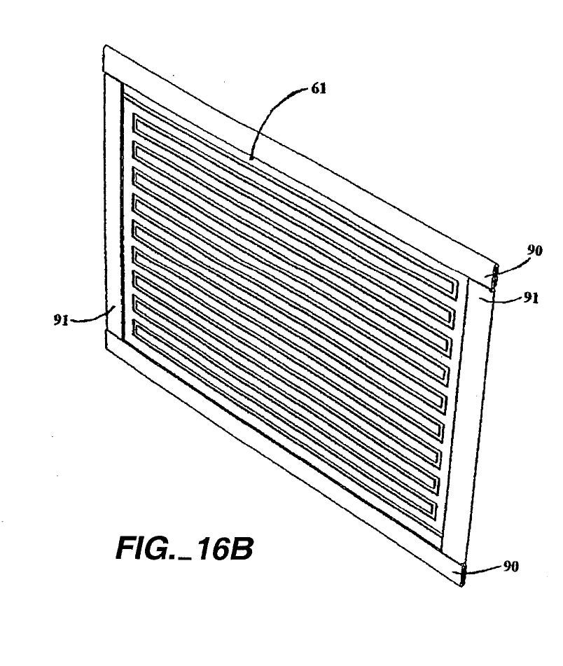

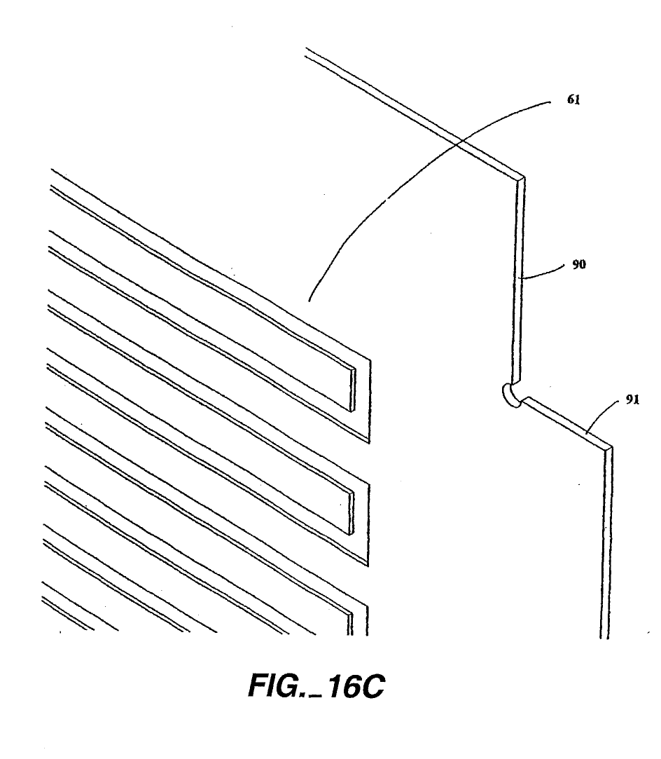

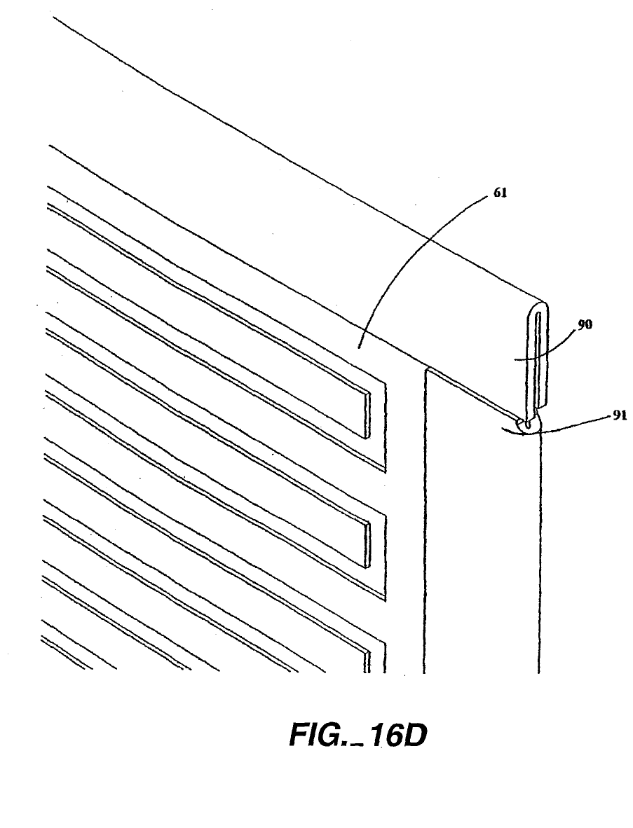

In order to support the sealing of the gaskets and/or sealing adhesives 64 the edges of the flexible or ridged bipolar separator plate 61 are bend over or rolled and/or crimped against the sealing surface of the membrane electrode assembly. (MEA). FIGS. 16A, 16B, 16C and 16D illustrate a method for achieving this end, shown without the MEA 65, gasket 64 for manifolds 51 for clarity. FIGS. 16A and 16C show a flexible or ridged bipolar separator plate 61 with extended edges 90, 91 before being rolled or crimped over the sealing edge as shown in FIGS. 16B and 16D. There are numerous methods for achieving the desired effect of mechanically restraining the edge of the adhesives or gaskets in order to prevent the release of reactants from the fuel cell well known to those trained in the mechanical arts. These methods include the simple bending and crimping or hemming as shown in FIGS. 16A through 16C but also include rolling the edges, the addition of secondary material such as a band around the periphery of the flexible or ridged bipolar separator plate. In addition, the corners need not be of a squared configuration but may be rounded in order to facilitate the rolling and or crimping of the edge or added material.

Any adhesives or gaskets incorporating adhesives necessarily must form an adequate bond with the bipolar separator plate and the membrane electrode assembly and between the bipolar separator plate and the membrane electrode assembly and between the bipolar separator plate and the manifold. Below are a few examples of adhesives, which may be of use in bonding the MEAs and manifolds to the BSPs:

Specific commercial tapes of the 3M Corp. (of St. Paul, Minn.) family of VHB (Very High Bond) Tapes, such as product number 4920, a closed-cell acrylic foam carrier with adhesive, or F-9469 PC, a adhesive transfer tape (trademarks of the 3M Company of St. Paul, Minn.).

Commercial acrylic adhesives such as Loctite Product 312 or 326 (trademark of the Loctite Corporation of Rocky Hill, Conn.) or 3M Scotch-Weld Acrylic Adhesive such as DP-805 or DP-820 (trademark of the 3M Company, St. Paul Minn.).

Specific epoxy products such as 3M 1838 (trademark of the 3M Company of St. Paul Minn.) or Loctite E-20HP. (Trademark of the Loctite Corporation of Rocky Hill, Conn.)

These examples are not to imply the only materials applicable to the bonding of the MEAs and the BSPs and the manifolds to the BSPs but only illustrate some of the suitable materials. These materials are applied with the typical methods made use of by those skilled in the art such as hand or robotic placement, hand or robotic dispensing, screen or stencil printing, rolling and spraying.

In one embodiment, 3M Company VHB tape #4920 closed cell acrylic foam with adhesive is used as described herein. This results in well-bonded manifolds to bipolar separator plates and MEAs to BSPs. The resulting fuel cell operates with comparable, better efficiency or significantly better efficiency than those fuel cells, which are conventional in the art.

The range of parameters useful in the present invention are summarized below in Table 1.

TABLE 1

| Feature | Specification |
|---|---|
| 1 Active Area | 0.0625-1600 sq. in. (0.4-10,300 sq. cm) |
| 2 Spring Finger Area | 0.005-5 sq. in. (0.3-32 sq. cm) |
| 3 Spring Pressure per Finger | 0.1-500 psi (0.007-3.4 MPa) |
| 4 Contact Area | 1-99% |
| 5 Hydrogen Gas Pressure | ambient - 10,000 psig (ambient 69 MPa) |
| 6 Oxygen/Air Gas Pressure | ambient - 10,000 psig (ambient 69 MPa) |
| 7 Current Density | 0.005-10 A/sq. cm |
| 8 BSP Thickness | 0.0005-0.5 in. (0.00127-1.27 cm) |
| 9 Number of Layers in BSP | 1-12 |

The following Examples are presented to be illustrative and descriptive only. They are not to be construed to be limiting in any way.

### EXAMPLE 1

A useful combination of features in an operating fuel cell is found below in Table 2.

TABLE 2

| Feature | Specification |
|---|---|
| 1 Active Area | 33 sq. in. (213 sq. cm) |
| 2 Spring Finger Area | 0.065 sq. in. (0.42 sq. cm) |
| 3 Spring Pressure per Finger | 45 psi (0.3 MPa) |
| 4 Contact Area | 48% |
| 5 Hydrogen Gas Pressure | 3 psig (0.122 MPa) |
| 6 Oxygen/Air Gas Pressure | ambient (0.122 MPa) |
| 7 Current Density | 300 mA/sq. cm |
| 8 BSP Thickness | 0.040 in. (0.1 cm) |
| 9 Number of Layers in BSP | 2 |

The spring material is 300 series stainless steel.

The spring (compliant contact) shape is FIG. 9M.

The BSP material is 300 series stainless steel.

The manifold material is polycarbonate.

The fuel cell is capable of producing 63 amps and 750 watts.

A fuel cell of this configuration is used in or as a portable power generator, a stationary power generator to supply the power requirements for small homes or apartments.

### EXAMPLE 2

A useful combination of features in an operating fuel cell is found below in Table 3.

TABLE 3

| Feature | Specification |
|---|---|
| 1 Active Area | 33 sq. in. (2.13 sq. cm) |
| 2 Spring Finger Area | 0.065 sq. in. (0.42 sq. cm) |
| 3 Spring Pressure per Finger | 103 psi (0.7 MPa) |
| 4 Contact Area | 68% |
| 5 Hydrogen Gas Pressure | 3 psi (0.122 MPa) |
| 6 Oxygen/Air Gas Pressure | ambient |
| 7 Current Density | 550 mA/sq. cm |
| 8 BSP Thickness | 0.040 in. (0.1 cm) |
| 9 Number of Layers in BSP | 2 |

The spring (compliant contact) shape is FIG. 9M.

The BSP material is 300 series stainless steel.

The manifold material is polycarbonate.

The fuel cell is capable of producing 117 amps and 1125 watts.

A fuel cell of this configuration is used in or as a portable power generator, a stationary power generator to supply the power requirements for small homes or apartments.

### EXAMPLE 3

A useful combination of features in an operating fuel cell is found below in Table 4.

TABLE 4

| Feature | Specification |
|---|---|
| 1 Active Area | 12 sq. in. (77 sq. cm) |
| 2 Spring Finger Area | 0.065 sq. in. (0.42 sq. cm) |
| 3 Spring Pressure per Finger | 138 psi (0.95 MPa) |
| 4 Contact Area | 62% |
| 5 Hydrogen Gas Pressure | 3 psig (0.122 MPa) |
| 6 Oxygen/Air Gas Pressure | ambient |
| 7 Current Density | 190 mA/sq. cm |
| 8 BSP thickness | 0.020 in. (0.5 cm) |
| 9 Number of Layers in BSP | 1 |

The spring material is 300 series stainless steel.

The spring (compliant contact) shape is FIG. 9M.

The BSP material is 300 series stainless steel.

The manifold material is acetal.

The fuel cell is capable of producing 14.7 amps and 169 watts.

A fuel cell of this configuration is used in or as a portable power generator for laptop computers, remote data collection systems, video cameras, electronic traffic signals, telecommunications equipment, etc.

### EXAMPLE 4

A useful combination of features in an operating fuel cell is found below in Table 5.

TABLE 5

| Feature | Specification |
|---|---|
| 1 Active Area | 180 sq. in. (1160 sq. cm) |
| 2 Spring Finger Area | 0.085 sq. in. (0.55 sq. cm) |
| 3 Spring Pressure per Finger | 130 psi (0.895 MPa) |
| 4 Contact Area | 78% |
| 5 Hydrogen Gas Pressure | 30 psig (0.31 MPa) |
| 6 Oxygen/Air Gas Pressure | 30 psig (0.31 MPa) |
| 7 Current Density (ambient forced | 1025 mA/sq. cm |
| convection) | |
| 8 BSP Thickness | 0.060 in. (0.15 cm) |
| 9 Number of Layers in BSP | 4 |

The spring (compliant contact) shape is FIG. 9P.

The BSP material is 300 series stainless steel.

The manifold material is composite.

The fuel cell is capable of producing 1190 amps and 13.7 kilowatts.

A fuel cell of this configuration is used in or as a portable power generator in home or for light commercial power generation systems, an automotive power system and other applications with moderate power requirements.

Improved Method of Generating Electrical Power

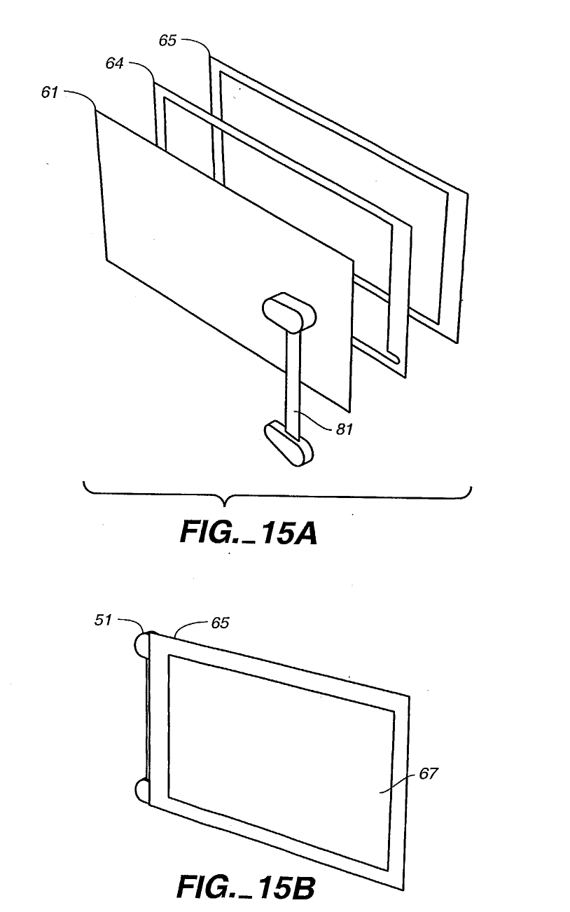

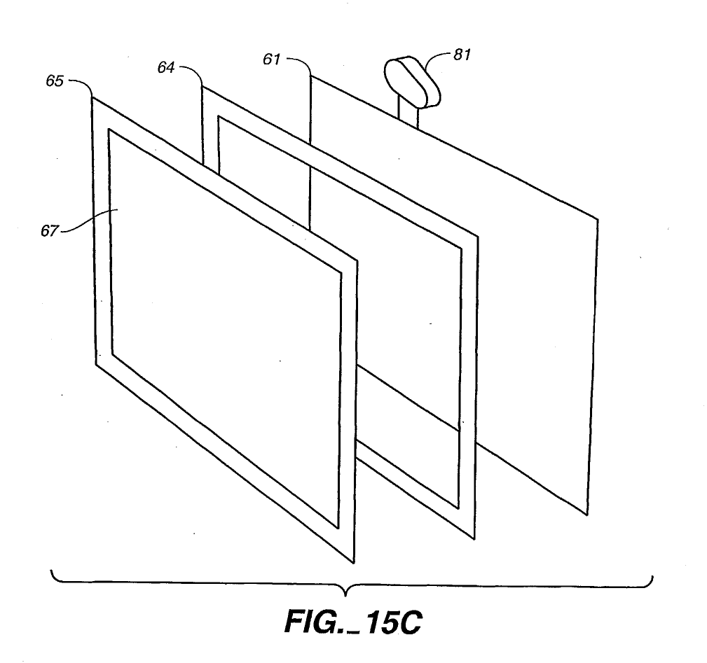

The present invention concerns an improved method of generating electrical power. The fuel cells described herein are utilized, see FIGS. 5-17B. The method involves the contacting of hydrogen gas and oxygen gases to produce water and electricity is described above.

While only a few embodiments of the invention have been shown and described herein, it will become apparent upon reading this application to those skilled in the art that various modifications and changes can be made to provide compliant electrical contacts, flexible or ridged modular BSP/MEA thin bipolar separator plates and components for fuel cells in a fully functioning fuel cell device without departing from the spirit and scope of the present invention. The present approach to produce a novel fuel cell is applicable to generally any cell geometry or configuration, such as rectangular, square, round or any other planar geometry or configuration. All such modifications and changes coming within the scope of the appended claims are intended to be carried out thereby.

We claim:

1. A fuel cell comprising:
a. a single flexible or ridged bipolar separator plate;
b. a flexible membrane electrode assembly;
c. a flexible bond, seal or gasket interposed between said single flexible or ridged separator plate and said flexible membrane electrode assembly, wherein said flexible bond, seal or gasket between said flexible or ridged separator plate and said flexible membrane electrode assembly comprises the fuel cell module, and wherein said flexible bond, seal or gasket may or not be an adhesive bond, seal or gasket which encapsulates edge portions of said flexible or ridged separator plate and said flexible membrane electrode assembly and wherein said flexible bond, seal or gasket seals the edge portions of said flexible membrane assembly to prevent the release of reactants from the fuel cell;
d. a manifold for the delivery and removal of reactants and reactant products to and from the fuel cell reactive areas where said manifolds may be either a single or multiple manifolds; and
e. a bond interposed between said manifold and said flexible or ridged separator plate, wherein said bond affixes said manifold to said flexible or ridged separator plate and wherein said bond provides a seal between said manifold and said flexible or ridged separator plate to prevent the release of reactants from the fuel cell.

2. A fuel cell comprising:
a. a single flexible or ridged bipolar separator plate;
b. a flexible membrane electrode assembly;
c. a flexible seal, adhesive or gasket interposed between said single flexible or ridged separator plate and said flexible membrane electrode assembly, wherein said flexible seal, adhesive or gasket between said flexible or ridged separator plate and said flexible membrane electrode assembly comprises the fuel cell module, and wherein said flexible seal, adhesive or gasket is optionally an adhesive which encapsulates edge portions of said flexible or ridged separator plate and said flexible membrane electrode assembly and wherein said flexible seal, adhesive or gasket seals the edge portions of said flexible membrane assembly to prevent the release of reactants from the fuel cell, and where the edge portion of the flexible or ridged separator plate is secured by rolling, bending over, crimping over the edge or combinations thereof of the said flexible membrane assembly and the said flexible seal and pressed or crimped against the said flexible membrane assembly and the said flexible seal to prevent the release of reactants from the fuel cell
d. a manifold for the delivery and removal of reactants and reactant products to and from the fuel cell reactive areas where said manifolds may be either a single or multiple manifolds; and
e. bond interposed between said manifold and said flexible or ridged separator plate, wherein said bond affixes said manifold to said flexible or ridged separator plate and wherein said bond provides a seal between said manifold and said flexible or ridged separator plate to prevent the release of reactants from the fuel cell.

3. The fuel cell of claims 1 or 2 wherein said fuel cell is assembled as a single cell module which is assembled with additional single cell modules to create a fuel cell stack or unit.

4. The fuel cell of claims 1 or 2 wherein said fuel cell module in claim 3 comprises said single flexible or ridged bipolar separator plate, said membrane electrode assembly, said flexible adhesive bond, seal or gasket between said single flexible or ridged bipolar separator plate and said membrane electrode assembly, said manifold or manifolds, said adhesive bond or bonds interposed between said manifold or manifolds and said flexible or ridged bipolar separator plate.

5. The fuel cell of claims 1 or 2 wherein said separator plate comprises a metal material, a composite material, a polymeric plastic material, or combinations thereof.

6. The fuel cell of claims 1 or 2 above wherein the separator plate has a thickness between about 0.0001 inch (0.000025 cm) and about 0.500 inch (1.25 cm) and area of between 0.1 inches square (0.0625 cm square) and 5000 inches square (31,250 cm square).

7. The fuel cell of claims 1 or 2 wherein the separator plate is of a square configuration, a rectangular configuration or other polygonal configuration, a circular configuration or any generally rounded configuration.

8. The fuel cell of claims 1 or 2 above wherein said adhesive, seal or gasket is applied to said separator plate or said adhesive, seal or gasket is applied to said membrane electrode assembly and said separator plate and said membrane electrode assembly are bonded and or sealed together as a single unit.

9. The fuel cell of claims 1 or 2 wherein said adhesive bond of subpart c in each is a gasket.

10. The fuel cell of claims 1 or 2 wherein the gasket comprises a plastic polymeric material, or an elastomeric material, a composite material, a metallic material, a foam material, or combinations thereof.

11. The fuel cell of claims 1 or 2 wherein said adhesive bond, seal or gasket of forms part of the reactant flow field.

12. The fuel cell of claims 1 or 2 wherein said manifolds are external to the BSP and the MEA as to not cause disruption or through holing of the MEA either internal or external to the electrochemically active area.

13. The fuel cell of claims 1 or 2 wherein said manifolds are bonded to said BSP.

14. The fuel cell of claims 1 or 2 wherein said manifolds comprise of a plastic material, or a composite material, or a metallic material.

15. The fuel cell of claims 1 or 2 wherein said manifold is a single manifold.

16. The fuel cell of claims 1 or 2 wherein said manifolds are multiple in nature up to at least 26 manifolds.

17. The fuel cell of claims 1 or 2 wherein said manifolds have passages for a single reactant or multiple reactants and or a coolant or multiple coolants.

18. The fuel cell of claims 1 or 2 wherein the said bond between said manifold or manifolds and said membrane electrode assembly comprises a plastic material, a elastomeric material, a composite material, a metallic material, a foam material, or combinations thereof.

19. The fuel cell of claim 2 wherein the bent, crimped or rolled edge is a separate part.

20. The fuel cell of claim 2 wherein the bent, crimped or rolled edge is continuous or discontinuous around the periphery the entire fuel cell.

21. The fuel cell of claims 1 and 2 wherein the bond, adhesive, seal or gasket material is applied manually, robotically, by printing, stenciling, silk screening, or other known methods of application.

22. The fuel cell of claim 8 wherein the gasket comprises a plastic polymeric material, an elastomeric material, a composite material, a metal, a foam or combinations thereof.

23. An array of independently acting compliant electrical contacts within a fuel cell electrode which improve fuel cell operation and performance by providing substantially increased and optimized surface area for increased electrical contact between the compliant contact attached to the conducting plate and bipolar separator plate and membrane electrode assembly, substantial uniform internal compressive loads and distribution resulting from the independent action of the compliant electrical contacts when the fuel cell stack is compressed.

24. The array of claim 23 wherein the compliant electrical contacts are in the form of a plurality of inverted V shaped metal springs or other configurations as described herein which are electrically contacted and connected mechanically, metallurgically or combinations thereof to a conducting base plate or bipolar separator plate.

25. The array of claim 23 wherein the compliant electrical contacts are in the form of a plurality of inverted V shaped metal arch springs having a cantilevered portion which are electrically contacted and connected mechanically, metallurgically or combinations thereof to a conducting base plate or bipolar separator plate.

26. The array of claim 23 wherein the compliant electrical contacts are in the form of a plurality of inverted rounded metal arch springs having a cantilevered portion which are electrically contacted and connected mechanically, metallurgically or combinations thereof to a conducting base plate or bipolar separator plate.

27. The array of claim 23 wherein the compliant electrical contacts are in the form of a plurality of inverted flat contact surface shaped metal arch springs having a cantilevered portion which are electrically contacted and connected mechanically, metallurgically or combinations thereof to a conducting base plate or bipolar separator plate.

28. The array of claim 23 wherein the compliant electrical contacts are in the form of a plurality of omega shaped metal springs with multiple deflection areas and multiple contact areas and which are electrically contacted and connected mechanically, metallurgically or combinations thereof to a conducting base plate or bipolar separator plate.

29. The array of claim 23 wherein the compliant electrical contacts are in the form of a plurality of omega shaped metal springs with multiple deflection areas and multiple contact areas, in strip form, and which are electrically contacted and connected mechanically, metallurgically or combinations thereof to a conducting base plate or bipolar separator plate.

30. The array of claim 23 wherein the compliant electrical contacts are in the form of a plurality of “S” shaped springs with right angle contact area with multiple deflection areas and having a flat area and which are electrically contacted and connected mechanically, metallurgically or combinations thereof to a conducting base plate or bipolar separator plate.

31. The array of claim 23 wherein the compliant electrical contacts are in the form of a plurality of “S” shaped springs with radiused right angle contact area, and interlocking and alignment/locating features with multiple deflection areas, and having a flat area and which are electrically contacted and connected mechanically, metallurgically or combinations thereof to a conducting base plate or bipolar separator plate.

32. The array of claim 23 wherein the compliant electrical contacts are in the form of a plurality of “S” shaped springs with radiused right angle contact area, and interlocking and alignment/locating features with multiple deflection areas, in strip form, and having a flat area and which are electrically contacted and connected mechanically, metallurgically or combinations thereof to a conducting base plate or bipolar separator plate.

33. The array of claim 23 wherein the compliant electrical contacts are in the form of a plurality of “Z” shaped springs with right angle contact area, and right angle mounting area, with multiple deflection areas and which are electrically contacted and connected mechanically, metallurgically or combinations thereof to a conducting base plate or bipolar separator plate.

34. The array of claim 23 wherein the compliant electrical contacts are in the form of a plurality of modified omega shaped springs with multiple deflection areas and a slight break in the top curve creating a slight peak and which are electrically contacted and connected mechanically, metallurgically or combinations thereof to a conducting base plate or bipolar separator plate.

35. The array of claim 23 wherein the compliant electrical contacts are in the form of a plurality of modified omega shaped metal springs with multiple deflection areas and a slight break in the top curve crating a slight peak, in strip form and which are electrically contacted and connected mechanically, metallurgically or combinations thereof to a conducting base plate or bipolar separator plate.

36. The array of claim 23 wherein the compliant electrical contacts are in the form of a plurality of modified omega shaped metal springs with multiple deflection areas and a smooth crown in the top curve leaving no peak and which are electrically contacted and connected mechanically, metallurgically or combinations thereof to a conducting base plate or bipolar separator plate.

37. The array of claim 23 wherein the compliant electrical contacts are in the form of a plurality of modified omega shaped metal springs with multiple deflection areas and a smooth crown in the curve leaving no peak, in strip form, and which are electrically contacted and connected mechanically, metallurgically or combinations thereof to a conducting base plate or bipolar separator plate.

38. The array of claim 23 individually or in strip form, wherein the strips form ventilated horizontal channels or passages to aid in air/oxygen flow to the fuel cell membrane and aid in the operation of the fuel cell.

39. The array of claim 23 individually or in strip form, wherein the strips form vertical ventilated channels or passageways (chimneys) to aid in air/oxygen flow to the fuel cell membrane and aid the operation of the fuel cell.

40. The array of claim 23 and all of its embodiments, wherein the combination of the compliant electrical contacts and the conducting base plate and bipolar separator plate create a substantially uniform thermal gradient for stable fuel cell operation and increased life.

41. The array of claim 23 wherein the compressive forces developed by the individual springs within the cell that are accommodated by the compliant electrical contacts is usually between about 0.10 lbsf (0.45 newton) and 50 lbsf (222.5 newton) per spring leaf or finger depending on the configuration as described herein.

42. The array in claim 23 wherein the compliant electrical contacts range in cross section from 0.030 in. (0.07 cm) to 3.00 in. (7.6 cm), but are not limited by size or shape.

43. The array of claim 23 wherein the spacing between compliant electrical contacts range from 0.005 in. (0.0125 cm) to 2.0 in. (5.08 cm), but are not limited by size or shape.

44. The array in claim 23 wherein the compliant electrical contacts range in length (across the fuel cell plate from 0.10 in. (0.25 cm) to 100.0 in. (250 cm), but are not limited by size or shape.

45. The conductive plates and bipolar separator plates that the array in claim 23 attach to are as small as about 0.25 in. (0.0625 cm)×0.25 in. (0.0625 cm) for very small, light, portable devices such as video cameras, movie cameras, etc. to large sizes of about 3 to 30 square meters required for homes, businesses, large buildings, or small cities.

46. The array of claim 23 wherein the compliant electrical contacts are in the form of a plurality of small metal pins which are electrically contacted and connected mechanically, metallurgically or combinations thereof to a conducting base plate or bipolar separator plate.

47. The array of claim 23 wherein the plurality of compliant electrical contacts form a regular patterned arrangement having a substantially uniform distance between contact points (surfaces), or the plurality of compliant electrical contacts (metal springs) have an irregular patterned arrangement and substantially non-uniformi distance between contact points (surfaces).

48. The array of claim 46 wherein the tips of the small metal pins in contact the adjacent electrode have a head similar to a nail head.

49. The array of claim 46 wherein the plurality of metal pins form a regular patterned arrangement having a substantially uniform distance between pins.

50. The compliant electrical contacts of claim 23 are selected from those shown in FIGS. 4A, 4B, 7, 8, 9A to 9P, 10 or 10A.

51. The array of claim 23 wherein the bipolar separator plates are selected from, very thin, very flexible metal bipolar separator plates (about 0.001 to 0.500 in. thick).

52. The array of claim 23 wherein the compliant electrical contacts (springs) have a thickness of the shaped metal strip between about 0.001 in. (0.0025 cm) and 0.090 in. (0.225 cm).

53. The array of claim 23 wherein the individual compliant electrical contact have a width of shaped metal strip between about 0.020 in. (0.05 cm) and 1.0 in. (2.5 cm).

54. The compliant electrical contact of claims 23 and 46 wherein the height of the configuration metal strip from base to electrical contact point(s) surface is between about 0.010 in. (0.025 cm) and 2.0 in. (0.05 cm), but not further limited by size or shape.

55. The array of claim 46 wherein the compliant electrical contacts are comprised of alloys of iron, copper, gold, silver, platinum, aluminum, nickel, chromium, and combinations thereof.

56. The array of claims 23 and) 46 wherein compliant electrical contacts are electrically, mechanically and/or metallurgically contacted and connected to the conducting plate or bipolar separator plate via soldering, brazing, welding, conductive adhesives, riveting, bolting, crimping or other metallurgical or mechanical method of attachment.

57. The array of claim 46 wherein the blank for the compliant electrical contacts are fabricated by etching, machining, stamping, fine blanking, coining, die cutting, extruding, laser cutting, hydro-forming, electro discharge machining, or other suitable methods of fabrication.

58. The array of claim 46 wherein the compliant electrical contacts are formed into the various shapes and configurations described herein by etching, machining, stamping, fine blanking, coining, die cutting, extruding, laser cutting, hydro-forming, electro discharge machining or other suitable methods of fabrication or forming.

59. The array of claim 46 wherein the conductive plates which are connected are fabricated by etching, stamping, machining, fine blanking, coining, die cutting, extruding, laser cutting, roll forming, hydro-forming or other suitable methods of fabrication.

60. An improved method of generating electrical power, which method comprises utilizing the fuel cell described in claim 1 or claim 2, which method comprises:
(a) contacting hydrogen gas at about ambient pressure or at a pressure about ambient pressure to 10,000 psig (6.9×10⁷ Pa) with oxygen or air in the presence of a catalyst in a reaction zone;
(b) producing water which is removed from the reaction zone; and
(c) producing a direct electrical current.

61. An improved method of generating electrical power, which method comprises utilizing the fuel cell described in claim 1 or claim 2, which method comprises:
(a) contacting hydrogen gas at about ambient pressure or at a pressure about ambient pressure to 10,000 psig (6.9×10⁷ Pa) with oxygen or air in the presence of a catalyst in a reaction zone;
(b) conducting hydrogen fuel through the passages of a first manifold to the active region of the cell which contains compliant contacts;
(c) contacting the hydrogen with the first side of the MEA which incorporates a catalyst;
(d) conducting oxygen on air through the passages of a second manifold;
(e) contacting the oxygen or air with the second side of said MEA;
(f) producing water which is removed through exit passages in the manifold; and
(g) producing direct electrical current.

62. The fuel cell of claims 1 or 2 wherein said single flexible or ridged bipolar separator plate is comprised of a single layer of material.

63. The fuel cell of claims 1 or 2 wherein said single flexible or ridged bipolar separator plate is comprised of multiple layers of material.

64. The fuel cell of claims 1 or 2 wherein said single flexible or ridged bipolar separator plate is fabricated by etching, machining, stamping, fine blanking, coining, die cutting, extruding, laser cutting, hydro-forming, electro discharge machining, or other suitable method of fabrication.

65. The fuel cell of claim 1 or 2 wherein said single flexible or ridged bipolar separator plate is has contained within it passages or volumes for the containment and flow of a cooling media such as water or other suitable liquid or gas for cooling said fuel cells during operation.

66. The array of claim 23 wherein the compliant electrical contacts are in the form of a plurality of “C” shaped metal springs with multiple deflection areas and multiple contact areas individually and in strip form and which are electrically contacted and connected mechanically, metallurgically or combinations thereof to a conduction base plate or bipolar separator plate.
